(19) United States
(12) Patent Application Publication
(10) Pub. No.: US 2021/0063861 A1
(43) Pub. Date: Mar. 4, 2021

(54) IMAGE PROCESSING APPARATUS AND IMAGE PROCESSING METHOD

(71) Applicant: CANON KABUSHIKI KAISHA, Tokyo (JP)

(72) Inventor: Hiroki Okino, Tokyo (JP)

(21) Appl. No.: 16/993,342

(22) Filed: Aug. 14, 2020

(30) Foreign Application Priority Data
Sep. 2, 2019 (JP) 2019-159697

(51) Int. Cl. G03B 21/20; H04N 9/31

(52) U.S. Cl. CPC G03B 21/2053; H04N 9/3155; H04N 9/3182; H04N 9/3185

(57) ABSTRACT

An image processing apparatus includes: a generation unit that converts at least one of brightness and a hue of an image at a position, at which a marker is drawn, to generate an conversion image; and an output unit that outputs the conversion image to a projection module, wherein the generation unit generates the conversion image so that a difference between at least one of the brightness and the hue of the image at the position at which the marker is drawn and at least one of brightness and a hue of the conversion image at the position at which the marker is drawn becomes larger in a case where another image projected by another apparatus overlaps the conversion image projected onto a projection surface by the projection module than in a case where another image does not overlap the conversion image on the projection surface.

### BACKGROUND OF THE INVENTION

### Field of the Invention

The present invention relates to an image processing apparatus and an image processing method.

### Description of the Related Art

In recent years, projection-type display apparatuses such as liquid-crystal projectors have come to be used widely, ranging from business use, i.e., presentations, conferences, or the like, to home use, i.e., home theaters or the like. Meanwhile, in a case in which a distortion occurs in the optical component or the housing of a projector due to a change in the internal temperature of the projector, an unintended change may occur in an area (projection area), in which an image is projected by the projector, on a projection surface (screen). As a result of such an unintended change in the projection area, an image projected by the projector is deviated from a desired position (desired area) on the projection surface. In a synthetic image constituted by a plurality of images projected by a plurality of projectors, a deviation occurs between the plurality of images, whereby a reduction in the sharpness of the synthetic image may occurs.

In view of this, there have been proposed technologies to draw and project a marker for adjusting a projection area on an image. Japanese Patent Application Laid-open No. 2017-32873 discloses a method for projecting a plurality of markers so as to be spatially deviated from each other so that the plurality of markers drawn on a plurality of images are distinguishable on a projection surface when a plurality of projectors project the plurality of images onto the projection surface. There have also been proposed methods for projecting a plurality of markers with a time lag.

However, according to the technology disclosed in Japanese Patent Application Laid-open No. 2017-32873, the marker portion of an image and the non-marker portion (the portion that is not a marker) of another image are overlapped with each other on a projection surface. Thus, compared with a case in which only one projector performs projection, the contrast between a marker and its periphery becomes lower and it becomes harder for the marker to be detected (from a captured image obtained by capturing a projection surface). The larger the number of images overlapped with the marker, the lower the contrast becomes and the harder the detection of the marker becomes. If the contrast is increased, the marker is easily detected. However, if the number of images overlapped with the marker reduces, the contrast becomes high and the marker is easily visually recognized.

### SUMMARY OF THE INVENTION

The present invention in its first aspect provides an image processing apparatus for drawing a marker on an image to generate a conversion image, the imaging processing apparatus comprising at least one memory and at least one processor which function as:

a generation unit configured to convert at least one of brightness and a hue of the image at a position, at which the marker is drawn, to generate the conversion image; and

an output unit configured to output the conversion image to a projection module which projects a projection image based on the conversion image, onto a projection surface, wherein

the generation unit generates the conversion image so that a difference between at least one of the brightness and the hue of the image at the position at which the marker is drawn and at least one of brightness and a hue of the conversion image at the position at which the marker is drawn becomes larger in a case where another image projected by another projection apparatus overlaps the projection image projected onto the projection surface by the projection module than in a case where another image does not overlap the projection image on the projection surface.

The present invention in its second aspect provides an image processing method for drawing a marker on an image to generate a conversion image, the imaging processing method comprising:

a generation step of converting at least one of brightness and a hue of the image at a position, at which the marker is drawn, to generate the conversion image; and

an output step of outputting the conversion image to a projection module which projects a projection image based on the conversion image, onto a projection surface, wherein

in the generation step, the conversion image is generated so that a difference between at least one of the brightness and the hue of the image at the position at which the marker is drawn and at least one of brightness and a hue of the conversion image at the position at which the marker is drawn becomes larger in a case where another image projected by another projection apparatus overlaps the projection image projected onto the projection surface by the projection module than in a case where another image does not overlap the projection image on the projection surface.

The present invention in its third aspect provides a non-transitory computer readable medium that stores a program, wherein the program causes a computer to execute an image processing method for drawing a marker on an image to generate a conversion image, the imaging processing method comprising:

a generation step of converting at least one of brightness and a hue of the image at a position, at which the marker is drawn, to generate the conversion image; and

an output step of outputting the conversion image to a projection module which projects a projection image based on the conversion image, onto a projection surface, wherein

in the generation step, the conversion image is generated so that a difference between at least one of the brightness and the hue of the image at the position at which the marker is drawn and at least one of brightness and a hue of the conversion image at the position at which the marker is drawn becomes larger in a case where another image projected by another projection apparatus overlaps the projection image projected onto the projection surface by the projection module than in a case where another image does not overlap the projection image on the projection surface.

Further features of the present invention will become apparent from the following description of exemplary embodiments with reference to the attached drawings.

### BRIEF DESCRIPTION OF THE DRAWINGS

FIG. 1 is a schematic view of a projection system;

FIG. 2 is a block diagram showing a configuration example of a projector;

FIG. 3 is a block diagram showing a configuration example of an image processing unit;

FIG. 4 is a flowchart showing an example of the basic operation of the projector;

FIG. 5 is a block diagram showing a configuration example of a PC;

FIG. 6 is a block diagram showing a configuration example of a camera;

FIG. 7 is a flowchart showing an example of the operation of the PC according to a first embodiment;

FIG. 8 is a view showing an example of a dot pattern (marker);

FIGS. 9A to 9H are views showing an example of the brightness distributions of various images;

FIGS. 10A to 10D are views showing an example of a change in a pixel value when a marker is drawn;

FIG. 11 is a flowchart showing an example of the operation of the PC according to the first embodiment;

FIG. 12 is a flowchart showing an example of the operation of the camera according to the first embodiment;

FIG. 13 is a flowchart showing an example of the operation of the projector according to the first embodiment;

FIGS. 14A to 14C are views showing an example of the brightness distributions of various images according to a second embodiment;

FIG. 15 is a flowchart showing an example of the operation of the PC according to a third embodiment;

FIGS. 16A and 16B are views showing an example of tile projection according to the third embodiment;

FIG. 17 is a flowchart showing an example of the operation of the PC according to a fourth embodiment; and

FIGS. 18A to 18C are views showing an example of the brightness distributions of various images according to a fifth embodiment.

### DESCRIPTION OF THE EMBODIMENTS

### First Embodiment

Hereinafter, a first embodiment of the present invention will be described.

Entire Configuration

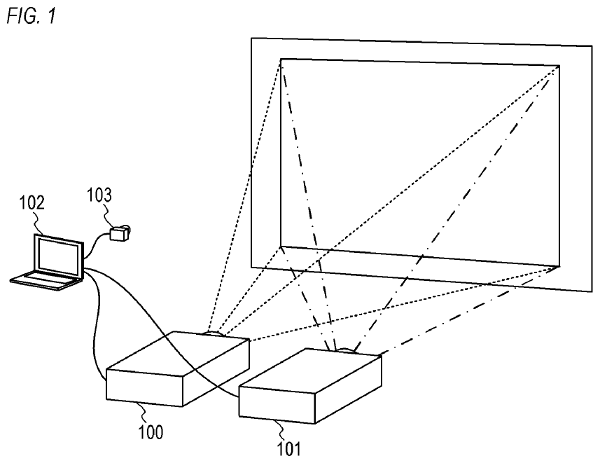

A projection system to which the present invention is applied will be roughly described with reference to FIG. 1. FIG. 1 is a schematic view of a projection system according to the first embodiment. As shown in FIG. 1, the projection system according to the first embodiment has projectors (projection apparatuses; projection modules) 100 and 101, a personal computer (PC) 102, and a camera 103.

The projector 100 is connected to the PC 102 by a cable such as a USB cable and an RS232C cable allowing command communication and capable of transmitting and receiving commands, images, or the like to and from the PC 102. Similarly, each of the projector 101 and the camera 103 is also connected to the PC 102. Note that the mode of connection thereamong is not particularly limited and connection is implemented through another wired connection such as a wired LAN or wireless connection such as a wireless LAN. The PC 102 is operable as an image processing apparatus that performs parameter control or area control for projection images of the projectors 100 and 101.

Each of the projectors 100 and 101 projects an image onto a projection surface (screen), but the image may not be successfully projected at a desired position (desired area) on the projection surface. In the first embodiment, it is desired that the area (projection area) of an image projected by the projector 100 on the projection surface coincide with the area (projection area) of an image projected by the projector 101 on the projection surface as shown in FIG. 1. However, there is a likelihood that the projection area of the projector 100 is deviated from the projection area of the projector 101. In view of this, the projection system according to the first embodiment performs the following two operations in addition to normal projection.

(1) The operation of adjusting the brightness (strength) of a marker drawn (synthesized) on a target image (an image to be projected) of the projector 100

(2) The operation of automatically correcting the deviation of a projection area of the projector 100 after the adjustment of the brightness of a marker

In the operation of adjusting the brightness of a marker, the PC 102 receives a user operation to specify the number of overlaps corresponding to the number of images projected by another projector and overlapping a target image of the projector 100 on a projection surface. Then, on the basis of the number of overlaps specified by the user operation, the PC 102 transmits an instruction to change the brightness of the marker to the projector 100. The projector 100 changes the brightness of the marker on the basis of the instruction from the PC 102.

In the operation of automatically correcting a deviation, the projector 100 draws a marker on a target image and projects the target image on which the marker has been drawn. The camera 103 captures a projection surface (an area including the projection area of the projector 100) and transmits the obtained captured image to the PC 102. The PC 102 detects the marker from the captured image received from the camera 103, analyzes the deviation of the projection area of the projector 100 on the basis of a detection result, and transmits a command for correcting the deviation of the projection area of the projector 100 to the projector 100 according to an analysis result. Then, the projector 100 corrects the deviation of the projection area on the basis of the command received from the PC 102.

Configuration of Projector 100

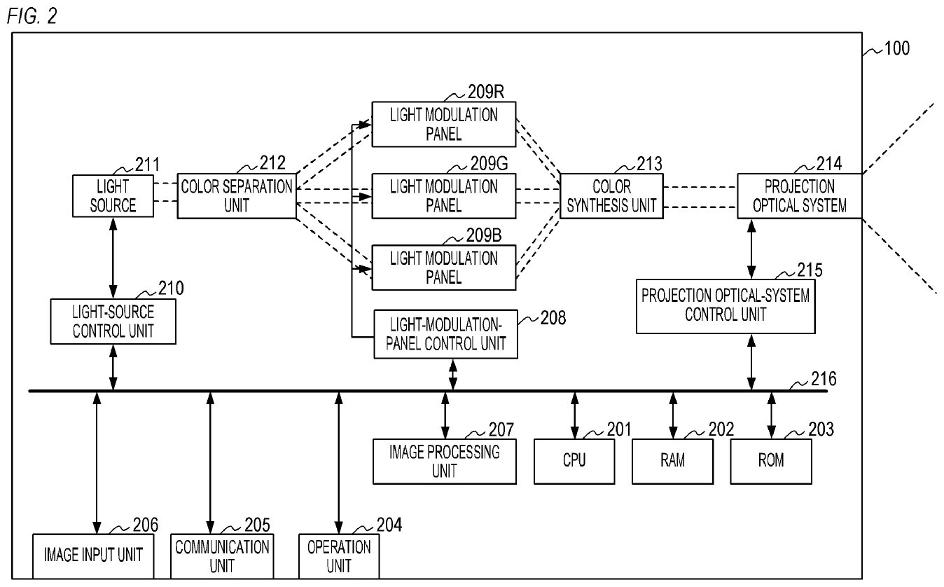

The configuration of the projector 100 will be described with reference to FIG. 2. FIG. 2 is a block diagram showing a configuration example of the projector 100. The projector 100 has a CPU 201, a RAM 202, a ROM 203, an operation unit 204, a communication unit 205, an image input unit 206, and an image processing unit 207. In addition, the projector 100 has a light-modulation-panel control unit 208, light modulation panels 209R, 209G, and 209B, a light-source control unit 210, a light source 211, a color separation unit 212, a color synthesis unit 213, a projection optical system 214, and a projection optical-system control unit 215. The CPU 201, the RAM 202, the ROM 203, the operation unit 204, the communication unit 205, the image input unit 206, the image processing unit 207, the light-modulation-panel control unit 208, the light-source control unit 210, and the projection optical-system control unit 215 are connected to a bus 216.

The CPU 201 controls the respective blocks (operation blocks) of the projector 100. On the ROM 203, a program (control program) in which the processing procedure of the CPU 201 is described is recorded. The RAM 202 is used as a work memory, and a program or data is temporarily stored in the RAM 202. The CPU 201 is also capable of temporarily storing image data (still-image data or moving-image data) acquired by the image input unit 206 or the communication unit 205 and reproducing an image (a still image or a moving image) based on the image data using a program recorded on the ROM 203.

The operation unit 204 is a reception unit capable of receiving an instruction from a user and transmits an instruction signal corresponding to the received instruction to the CPU 201. The operation unit 204 has, for example, a switch, a dial, or the like. The operation unit 204 may be a signal reception unit (such as an infrared reception unit) that receives a signal from a remote controller. Upon receiving an instruction signal transmitted from the operation unit 204, the CPU 201 controls the respective blocks of the projector 100 according to the instruction signal.

The image input unit 206 acquires image data from an external apparatus. Here, the type of the external apparatus is not particularly limited so long as the image input unit 206 is allowed to acquire image data from the external apparatus. The external apparatus is, for example, a personal computer, a camera, a mobile phone, a smart phone, a hard disk recorder, a video game machine, or the like. The external apparatus may be a storage medium (storage device) such as a USB flash memory and an SD card.

The image processing unit 207 applies image processing to image data acquired by the image input unit 206 or the communication unit 205 and transmits image data to which the image processing has been applied to the light-modulation-panel control unit 208. The image processing unit 207 is, for example, a micro processor for image processing.

The light-source control unit 210 controls the on/off or the light amount of the light source 211.

The light source 211 emits light for projecting an image onto a projection surface. The light source 211 is, for example, a halogen lamp, a xenon lamp, a high-pressure mercury lamp, a laser, an LED, a fluorescent substance, or the like. A plurality of types of light sources may be used in combination as the light source 211.

The color separation unit 212 separates light emitted from the light source 211 into red light, green light, and blue light. The color separation unit 212 is, for example, a dichroic mirror, a prism, or the like. Note that the color separation unit 212 is not necessary when a light source for emitting red light, a light source for emitting green light, and a light source for emitting blue light are used in combination as the light source 211.

The light-modulation-panel control unit 208 controls the light modulation ratios (light modulation ratio distributions) of the light modulation panels 209R, 209G, and 209B on the basis of image data output from the image processing unit 207. By, for example, controlling a voltage applied to the light modulation panels 209R, 209G, and 209B, the light-modulation-panel control unit 208 controls the light modulation ratios of the light modulation panels 209R, 209G, and 209B.

Each of the light modulation panels 209R, 209G, and 209B is a light modulation panel that modulates light with a light modulation ratio (light modulation ratio distribution) based on image data output from the image processing unit 207. Each of the light modulation panels 209R, 209G, and 209B is, for example, a transmission panel that causes light to pass therethrough with a transmission ratio (transmission ratio distribution) based on image data output from the image processing unit 207 and is a liquid-crystal panel or the like. Each of the light modulation panels 209R, 209G and 209B has a plurality of light modulation elements (such as liquid-crystal elements), and the light modulation ratios of the respective light modulation elements are controlled on the basis of image data output from the image processing unit 207.

The light modulation panel 209R is a light modulation panel for red and modulates red light obtained by the color separation unit 212. The light modulation panel 209G is a light modulation panel for green and modulates green light obtained by the color separation unit 212. The light modulation panel 209B is a light modulation panel for blue and modulates blue light obtained by the color separation unit 212.

The color synthesis unit 213 synthesizes red light that has been modulated (transmitted) by the light modulation panel 209R, green light that has been modulated (transmitted) by the light modulation panel 209G; and blue light that has been modulated (transmitted) by the light modulation panel 209B. The color synthesis unit 213 is, for example, a dichroic mirror, a prism, or the like. Light that has been synthesized by the color synthesis unit 213 is transmitted to the projection optical system 214.

The projection optical-system control unit 215 controls the projection optical system 214.

The projection optical system 214 projects light from the color synthesis unit 213 onto a projection surface. The projection optical system 214 has, for example, a plurality of lenses, an actuator for driving the lenses, or the like. By driving the lenses with the actuator, the projection optical system 214 is allowed to perform the enlargement, reduction, focus adjustment, or the like of a projection image (an image that has been displayed on the projection surface by the projection of light). If the light modulation ratios (light modulation ratio distributions) of the light modulation panels 209R, 209G, and 209B are controlled on the basis of image data that has been output from the image processing unit 207, an image based on the image data that has been output from the image processing unit 207 is obtained as a projection image.

The communication unit 205 performs communication with an external apparatus to acquire image data from the external apparatus or receive a control signal from the external apparatus. The communication unit 205 transmits the received control signal to the CPU 201. Upon receiving the control signal transmitted from the communication unit 205, the CPU 201 controls the respective blocks of the projector 100 according to the control signal. Here, the communication system of the communication unit 205 is not particularly limited. Communication by the communication unit 205 is, for example, communication using a wireless LAN, a wired LAN, a USB, Bluetooth (registered trademark), infrared light, or the like. When the terminal of the image input unit 206 is an HDMI (registered trademark) terminal, communication by the communication unit 205 may be CEC communication via the HDMI terminal of the image input unit 206. The type of the external apparatus is not particularly limited so long as the external apparatus is capable of performing communication with the projector 100 (the communication unit 205). The external apparatus is, for example, shutter glasses, a personal computer, a camera, a mobile phone, a smart phone, a hard disk recorder, a video game machine, a remote controller, or the like.

Note that the light-modulation-panel control unit 208, the light-source control unit 210, and the projection optical-system control unit 215 may be replaced by one or a plurality of microprocessors (microprocessors for control) allowed to perform the same processing as those of the blocks. The projector 100 may separately has, for example, a micro processor that functions as the light-modulation-panel control unit 208, a microprocessor that functions as the light-source control unit 210, and a microprocessor that functions as the projection optical-system control unit 215. The processing of at least two blocks among the light-modulation-panel control unit 208, the light-source control unit 210, and the projection optical-system control unit 215 may be performed by the same processor. According to a program recorded on the ROM 203, the CPU 201 may perform the same processing as those of at least any of the light-modulation-panel control unit 208, the light-source control unit 210, and the projection optical-system control unit 215.

Internal Configuration of Image Processing Unit 207

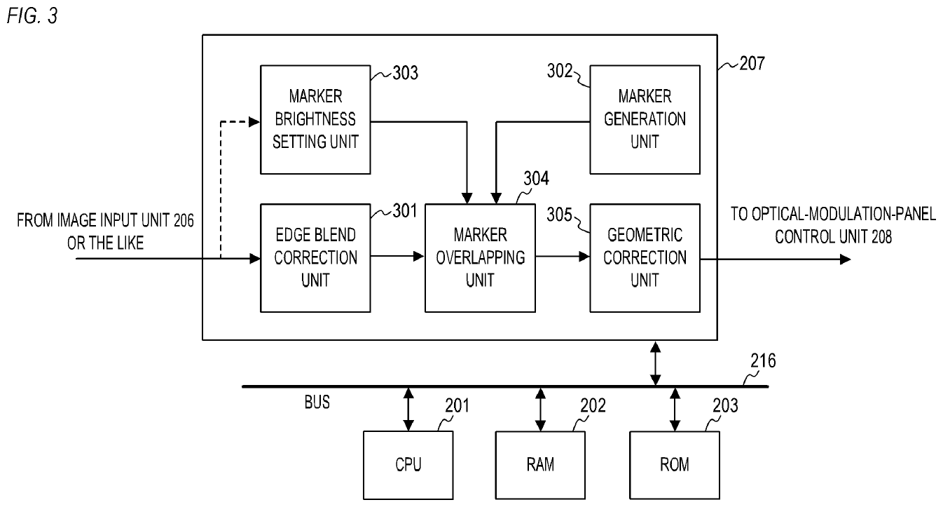

The internal configuration of the image processing unit 207 will be described with reference to FIG. 3. FIG. 3 is a block diagram showing a configuration example of the image processing unit 207. The image processing unit 207 has an edge blend correction unit 301, a marker generation unit 302, a marker brightness setting unit 303, a marker overlapping unit 304, and a geometric correction unit 305. The respective blocks of the image processing unit 207 are connected to the CPU 201 or the like via a bus 216. The execution/inexecution of the processing of the respective blocks of the image processing unit 207 is switched by the CPU 201. Image data input to the image processing unit 207 is appropriately subjected to image processing by the respective blocks of the image processing unit 207 and then output from the image processing unit 207.

There is a case that a part of a projection image and a part of another projection image are overlapped with each other to constitute a synthetic image in which the plurality of projection image projected from a plurality of projectors are synthesized. In such a case, the edge blend correction unit 301 performs dimmer processing on an area (overlapped area) in which at least two projection images are overlapped with each other. Specifically, the edge blend correction unit 301 performs dimmer processing on an image from the image input unit 206 or the communication unit 205 on the basis of the width and the position of an overlapped area specified by the CPU 201. The dimmer processing is processing to adjust the brightness of at least one of an overlapped area and a non-overlapped area (an area that is not overlapped) so that a brightness difference between the overlapped area and the non-overlapped area is reduced. The dimmer processing is performed by respective projectors. Note that in the first embodiment, the entire area of a projection image of the projector 100 is overlapped with the entire area of a projection image of the projector 101 as shown in FIG. 1. Since the dimmer processing is not necessary in this case, the CPU 201 makes a setting so as not to perform the image processing (dimmer processing) by the edge blend correction unit 301. For this reason, an input image input to the edge blend correction unit 301 and an output image output from the edge blend correction unit 301 are the same in the first embodiment. An output image output from the edge blend correction unit 301 is input to the marker overlapping unit 304.

The marker generation unit 302 generates a marker image. The marker image is an image in which the pixel value (the gradation value, i.e., the brightness value) of pixels (marker pixels) constituting a marker is A and the pixel value of pixels (pixels not constituting the marker, i.e., non-marker pixels) constituting the background of the marker is B. The pixel value A and the pixel value B may take any value so long as the values are different from each other. The pixel value A is, for example, 255, and the pixel value B is, for example, zero. The marker generation unit 302 outputs a marker image to the marker overlapping unit 304.

The marker brightness setting unit 303 outputs a marker control signal related to the brightness of a marker to the marker overlapping unit 304. The marker control signal is, for example, a signal for setting brightness obtained by changing the brightness of a target image (an image output from the edge blend correction unit 301) as the brightness of a marker (marker pixels) and shows the change amount (offset amount) of the brightness of the target image. The offset amount is set in the marker brightness setting unit 303 by the CPU 201, and the marker brightness setting unit 303 generates and outputs the marker control signal on the basis of the set offset amount.

The marker overlapping unit 304 synthesizes a marker image from the marker generation unit 302 with a target image (an image from the edge blend correction unit 301) on the basis of a marker control signal from the marker brightness setting unit 303. A specific example will be described. First, the marker overlapping unit 304 converts the pixel value A of marker pixels in a marker image into a pixel value corresponding to an offset amount (a brightness difference) corresponding to a marker control signal to generate an intermediate image. In the intermediate image, the pixel value of non-marker pixels is 0 corresponding to a brightness of 0. Next, the marker overlapping unit 304 performs offset processing to add the respective pixel values of the intermediate image to the respective pixel values of the target image or subtract the respective pixel values of the intermediate image from the respective pixel values of the target image. Thus, a marker is drawn on the target image. The marker overlapping unit 304 outputs an image (marker overlapped image) on which the marker has been drawn to the geometric correction unit 305. Note that the marker is drawn at the subsequent stage of the edge blend correction unit 301 as shown in FIG. 3, whereby it is possible to prevent the pixel value of the marker from being changed by dimmer processing.

The geometric correction unit 305 applies geometric correction to a marker overlapped image from the marker overlapping unit 304 so as to reduce the deviation of a projection area. Then, the geometric correction unit 305 outputs an image to which the geometric correction has been applied as an output image of the image processing unit 207. The geometric correction is, for example, projection conversion, image-position shifting, warping correction, or the like.

Basic Operation of Projector 100

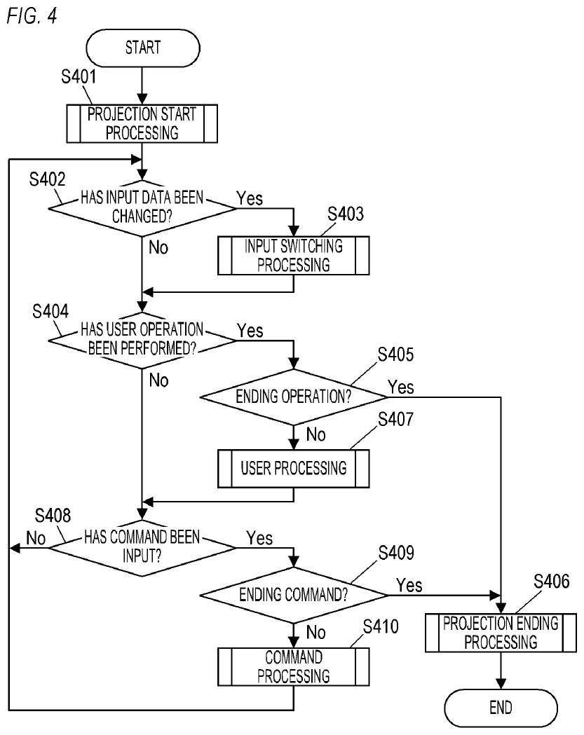

The basic operation of the projector 100 will be described with reference to FIG. 4. FIG. 4 is a flowchart showing an example of the basic operation of the projector 100. The operation of FIG. 4 is realized, for example, when the CPU 201 controls the respective blocks on the basis of a program recorded on the ROM 203. The operation of FIG. 4 starts as a user provides an instruction to turn on the projector 100 using the operation unit 204 or a remote controller. Here, an image based on image data (input data) acquired by the image input unit 206 is a target image (an image to be projected (or displayed)).

In S401, the CPU 201 supplies power from a power supply unit (power supply circuit) not shown to the respective blocks of the projector 100 to perform projection start processing. For example, in the projection start processing, the CPU 201 instructs the light-source control unit 210 to turn on the light source 211, instructs the light-modulation-panel control unit 208 to drive the light modulation panels 209R, 209G; and 209B, and makes a setting to operate the image processing unit 207. By the projection start processing, a target image (light based on the target image) is projected onto a projection surface to obtain a projection image based on the target image.

In S402, the CPU 201 determines whether input data has been changed (switched). The processing proceeds to S403 when it is determined that the input data has been changed. Otherwise (when it is determined that the input data has not been changed), the processing proceeds to S404.

In S403, the CPU 201 performs input switching processing. In the input switching processing, the CPU 201 detects, for example, the resolution, the frame rate, or the like of the input data. Then, the CPU 201 controls the respective blocks so that the input data is sampled at a timing suitable for the detected resolution or frame rate to perform necessary image processing. Thus, the projection image is favorably switched to a projection image based on a new target image.

In S404, the CPU 201 determines whether a user has performed a user operation (an operation performed by the user on the operation unit 204, a remote controller, or the like). The processing proceeds to S405 when it is determined that the user operation has been performed. Otherwise (when it is determined that the user operation has not been performed), the processing proceeds to S408.

In S405, the CPU 201 determines whether the user operation that has been performed is an ending operation. The processing proceeds to S406 when it is determined that the user operation that has been performed is the ending operation. Otherwise (when it is determined that the user operation that has been performed is not the ending operation), the processing proceeds to S407.

In S406, the CPU 201 performs projection ending processing. For example, in the projection ending processing, the CPU 201 instructs the light-source control unit 210 to turn off the light source 211, instructs the light-modulation-panel control unit 208 to stop the driving of the light modulation panels 209R, 2090; and 209B, and stores necessary settings in the ROM 203. By the projection ending processing, the projection of the target image (the light based on the target image) is ended to delete the projection image.

In S407, the CPU 201 performs processing (user processing) corresponding to the user operation that has been performed. The CPU 201 performs, for example, the change of the setting of installation, the change of input data, the change of image processing, the display of information, or the like.

In S408, the CPU 201 determines whether a command (control command) has been input from the communication unit 205. The processing proceeds to S409 when it is determined that the command has been input. Otherwise (when it is determined that the command has not been input), the processing returns to S402.

In S409, the CPU 201 determines whether the command input from the communication unit 205 is an ending command. The processing proceeds to S406 (the projection ending processing) when it is determined that the command input from the communication unit 205 is the ending command. Otherwise (when it is determined that the command input from the communication unit 205 is not the ending command), the processing proceeds to S410.

In S410, the CPU 201 performs processing (command processing) corresponding to the command input from the communication unit 205. The CPU 201 performs, for example, the setting of installation, the setting of input data, the setting of image processing, the acquisition of a state, or the like.

Note that the target image is not limited to an image based on image data acquired by the image input unit 206. For example, the projector 100 is also capable of developing image data acquired by the communication unit 205 into the RAM 202 and projecting (displaying) an image based on the image data. Therefore, the target image may be an image based on image data acquired by the communication unit 205. The projector 100 may have a storage unit storing image data, and an image based on the image data recorded on the storage unit may be used as the target image.

Configuration of PC 102

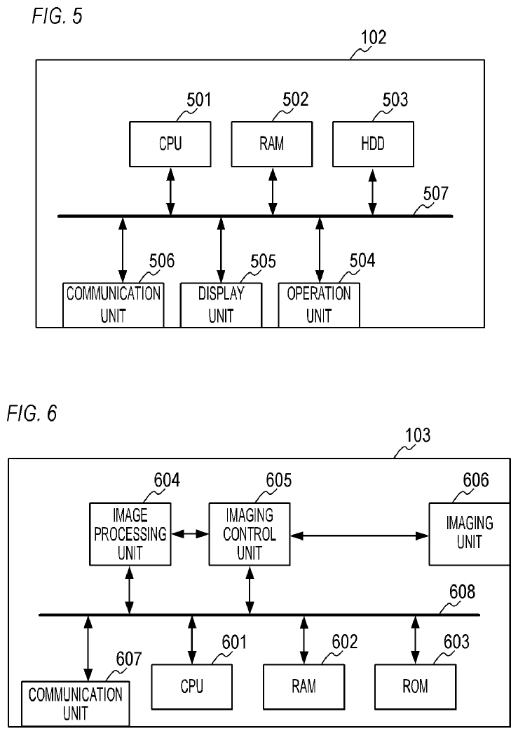

The configuration of the PC 102 will be described with reference to FIG. 5. FIG. 5 is a block diagram showing a configuration example of the PC 102. The PC 102 has a CPU 501, a RAM 502, a HDD 503, an operation unit 504, a display unit 505, and a communication unit 506. The CPU 501, the RAM 502, the HDD 503, the operation unit 504, the display unit 505, and the communication unit 506 are connected to a bus 507.

The CPU 501 controls the respective blocks (operation blocks) of the PC 102. The RAM 502 is a volatile memory and used as a work memory where the CPU 501 operates. The HDD 503 is a hard disk unit and used to store various data. The stored data includes an operating system (OS) that causes the CPU 501 to operate, a program code for an application, data used to perform the OS and the program code, a multimedia content, or the like.

The operation unit 504 is an input device that receives an instruction from a user and is a keyboard, a mouse, or the like. The display unit 505 is a display monitor that displays information presenting to the user or the like. Note that sound may be output from a speaker to inform the user of information.

The communication unit 506 is used to transmit and receive still-image data, moving-image data, a control command, a signal, or the like to and from an external apparatus and performs communication through, for example, a wireless LAN, a wired LAN, a USB, Bluetooth (registered trademark), infrared light, or the like. Here, the external apparatus may be any type of an apparatus such as a projector, another personal computer, a camera, a mobile phone, a smart phone, a hard disk recorder, and a video game machine so long as the apparatus is allowed to perform communication with the PC 102. The communication unit 506 is capable of communicating with the communication unit 205 of the projector 100 or a communication unit 607 of the camera 103 that will be described later.

Note that in the first embodiment, the PC 102 is allowed operate two applications. One of the applications is an application for adjusting the brightness of a marker of the projector 100. The application receives an instruction to start or end the brightness adjustment of the marker of the projector 100 and communicates with the projector 100 to adjust the brightness of the marker of the projector 100. The other of the applications is an application for automatically correcting the deviation of the projection area of the projector 100. The application receives an instruction to start or end the automatic correction of a deviation and cooperates with the projector 100 and the camera 103 to analyze and correct the deviation.

Configuration of Camera 103

The configuration of the camera 103 will be described with reference to FIG. 6. FIG. 6 is a block diagram showing a configuration example of the camera 103. The camera 103 has a CPU 601, a RAM 602, a ROM 603, an image processing unit 604, an imaging control unit 605, an imaging unit 606, and a communication unit 607. The CPU 601, the RAM 602, the image processing unit 604, the imaging control unit 605, and the communication unit 607 are connected to a bus 608.

The CPU 601 controls the respective blocks (operation blocks) of the camera 103. The RAM 602 is a volatile memory and used as a work memory where the CPU 601 operates. In the ROM 603, a control program in which the processing procedure of the CPU 601 is described is stored.

The image processing unit 604 codes or compresses an imaging signal captured by the imaging unit 606 to generate captured image data in a JPEG format, a TIFF format, or the like.

The imaging control unit 605 is used to control the imaging unit 606 and composed of a microprocessor for control. Note that the imaging control unit 605 is not necessarily a dedicated microprocessor. For example, the CPU 601 may perform the same processing as that of the imaging control unit 605 according to a program stored in the ROM 603. The imaging control unit 605 acquires an imaging signal captured by the imaging unit 606 from the imaging unit 606 and transmits the acquired imaging signal to the image processing unit 604.

The imaging unit 606 is used to acquire an imaging signal by capturing an external object and transmit the captured imaging signal to the imaging control unit 605. The imaging unit 606 is composed of an imaging optical system, an optical sensor, or the like.

The communication unit 607 is used to transmit and receive still-image data, moving-image data, a control command, a signal, or the like to and from an external apparatus and performs communication through, for example, a wireless LAN, a wired LAN, a USB, Bluetooth (registered trademark), infrared light, or the like. Here, the external apparatus may be any type of an apparatus such as a projector, a personal computer, another camera, a mobile phone, a smart phone, and a hard disk recorder so long as the apparatus is allowed to perform communication with the camera 103. The communication unit 607 is capable of communicating with the communication unit 506 of the PC 102.

Operation of Adjusting Marker Brightness by PC 102

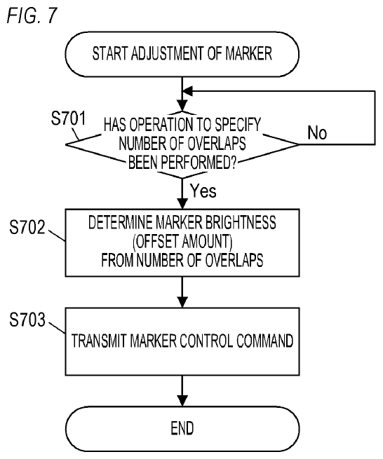

The operation of adjusting marker brightness by the PC 102 will be described with reference to FIG. 7. FIG. 7 is a flowchart showing an example of the operation of adjusting marker brightness by the PC 102. The operation of FIG. 7 is realized, for example, when the CPU 501 controls the respective blocks on the basis of a program recorded on the ROM 502. The operation of FIG. 7 starts as a user provides an instruction to start the adjustment of marker brightness using the operation unit 504.

In S701, the CPU 501 determines whether a user operation to specify the number of overlaps of projection images has been performed. The user is allowed to specify the number of overlaps using the operation unit 504. As described above, the number of overlaps corresponds to the number of images overlapped with each other on the projection surface, the images including a target image of the projector 100 and an image projected by another projector. For example, when totally two projection images of a projection image of the projector 100 and a projection image of the projector 101 are overlapped with each other as shown in FIG. 1, “2” is specified as the number of overlaps. When only the projection image of the projector 100 is projected, “1” is specified as the number of overlaps. The number of overlaps “1” represents that the projection image of the projector 100 is not overlapped with a projection image of another projector. The CPU 501 is capable of making a setting as to whether the projection image of the projector 100 is overlapped with a projection image of another projector, specifically, the number of overlaps. When it is determined that the user operation to specify the number of overlaps has been performed, the CPU 501 sets the specified number of overlaps and then the processing proceeds to S702. Otherwise (when it is determined that the user operation to specify the number of overlaps has not been performed), the processing of S701 is repeatedly performed until the user operation to specify the number of overlaps has been performed.

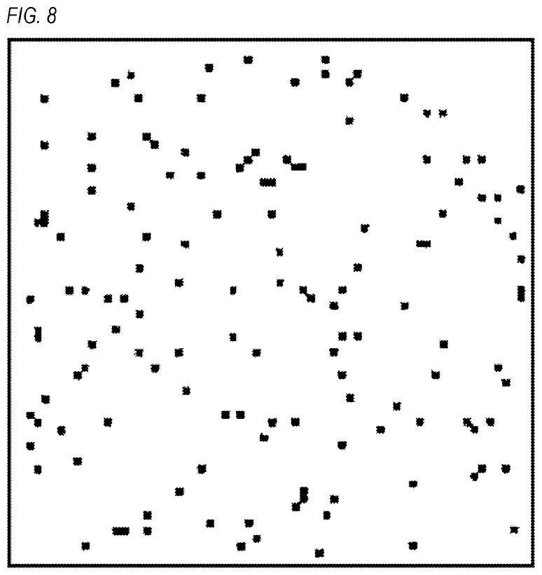

In S702, the CPU 501 determines the brightness of a marker drawn on the target image of the projector 100, specifically, an offset amount (the change amount of the brightness of the target image to determine the brightness of the marker) on the basis of the specified number of overlaps. The CPU 501 determines the offset amount so that the change amount of the brightness of the target image on which the marker has been drawn relative to the brightness of the original target image becomes larger in a case in which the specified number of overlaps is “2” than in a case in which the specified number of overlaps is “1.” As the marker, a dot pattern as shown in FIG. 8 that is obtained by coding two-dimensional coordinates (positions) according to, for example, a method described in U.S. Pat. No. 7,907,795 is formed. The dot pattern shown in FIG. 8 is one obtained by coding the two-dimensional coordinates (prescribed coordinates) of prescribed pixels in the target image. With the comparison between coordinates obtained by decoding a captured image of the dot pattern on the projection surface and the above prescribed coordinates, it is possible to determine the deviation or the distortion of a projection area.

In S703, the CPU 501 transmits a command (marker control command) for setting the brightness of the marker, specifically, the offset amount to the projector 100 via the communication unit 506. The marker control command contains marker information on the brightness of the marker. The marker information shows, for example, the offset amount described above. Upon receiving the marker control command via the communication unit 205, the CPU 201 of the projector 100 sets the brightness of the marker, specifically, the offset amount in the marker brightness setting unit 303 on the basis of the received marker control command. Accordingly, the brightness of the marker drawn on the target image of the projector 100 is controlled when the PC 102 transmits the marker control command to the projector 100.

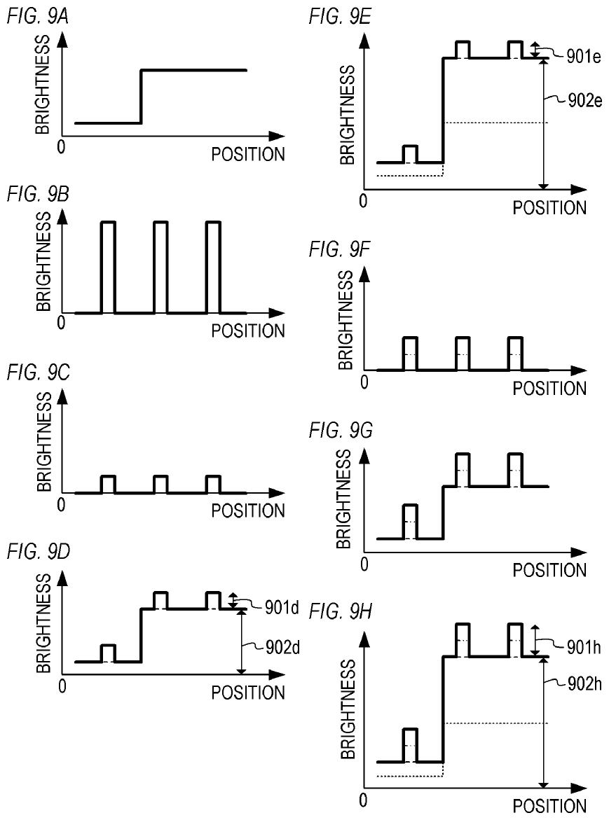

In this manner, the PC 102 controls the brightness of a marker on the basis of the number of overlaps. Thus, it is possible to make a marker easily detectable while making the same hardly visually recognizable regardless of the number of projection images overlapped with each other on a projection surface. The mechanism will be described with reference to FIGS. 9A to 9H. FIGS. 9A to 9H schematically show the drawn state of a marker using a horizontal axis showing a pixel position and a vertical axis showing brightness.

First, an example of a case (the number of overlaps=1) in a case in which only the projector 100 performs projection and a projection image of another projector does not overlap a projection image of the projector 100 will be described. FIG. 9A shows an example of a target image of the projector 100. The target image of FIG. 9A is input to the marker overlapping unit 304. FIG. 9B shows an example of a marker image generated by the marker generation unit 302. The marker image of FIG. 9B is input to the marker overlapping unit 304. FIG. 9C shows an example of an intermediate image generated when the marker overlapping unit 304 converts the marker image of FIG. 9B on the basis of a marker control signal from the marker brightness setting unit 303. FIG. 9D shows an example of a marker overlapped image obtained when the marker overlapping unit 304 synthesizes the target image of FIG. 9A with the intermediate image of FIG. 9C. In the marker overlapped image of FIG. 9D, the brightness of the marker is brightness in which the brightness of the intermediate image of FIG. 9C is added to the brightness of the target image of FIG. 9A.

The higher the contrast between the marker and its periphery on a projection surface, the easier the detection of the marker from a captured image obtained by capturing the projection surface with the camera 103 becomes. However, the visual recognition of the marker becomes easier instead. For this reason, the contrast is preferably the smallest contrast with which it is possible to detect the marker from the captured image. That is, it is preferable to control the brightness of the marker in the marker overlapped image, specifically, the brightness (offset amount) of the marker in the intermediate image so that the above contrast becomes the minimum contrast with which it is possible to detect the marker from the captured image. In this manner, it is possible to make the marker easily detectable while making the same hardly visually recognizable.

Note that the above contrast may be calculated by dividing a brightness difference (offset amount) ΔC between the marker and its periphery on the projection surface by brightness C on the periphery of the marker on the projection surface as shown in the following formula 1. In the example of FIG. 9D, the above contrast may be calculated by dividing a brightness difference 901d by brightness 902d.

Contract=ΔC/C (Formula 1)

Next, an example of a case (the number of overlaps=2) in which a projection image of the projector 100 and a projection image of the projector 101 are overlapped with each other will be described. Note that the projection image of the projector 100 is the same as the projection image of the projector 101 before a marker is drawn. Thus, it is possible to obtain a projection image having brightness (a synthetic image in which the projection image of the projector 100 and the projection image of the projector 101 are overlapped with each other) higher than that of the projection image of the projector 100.

When the projection image of the projector 100 and the projection image of the projector 101 are overlapped with each other, the projection image of the projector 101 is overlapped with the marker overlapped image of FIG. 9D that is the projection image of the projector 100. Here, the projector 101 does not project a marker. For this reason, an image equivalent to the target image of FIG. 9A is overlapped with the marker overlapped image of FIG. 9D as the projection image of the projector 101.

FIG. 9E shows a state in which the target image of FIG. 9A that is the projection image of the projector 101 is overlapped with the marker overlapped image of FIG. 9D that is the projection image of the projector 100. In FIG. 9E, a brightness difference 901e is a brightness difference ΔC between the marker and its periphery. Brightness 902e is brightness C on the periphery of the marker and the sum of the brightness (brightness of FIG. 9D) of the projection image of the projector 100 and the brightness (brightness of FIG. 9A) of the projection image of the projector 101. In FIG. 9E, the projection image of the projector 101 is overlapped, whereby the brightness C becomes higher and the contrast between the marker and its periphery becomes lower compared with the case of FIG. 9D in which only the projector 100 performs projection. As a result, the detection of the marker becomes harder.

In view of this, the PC 102 (CPU 501) makes an offset amount (a change amount from the brightness of the target image to the brightness of the marker) larger in a case in which the number of overlaps is 2 than in a case in which the number of overlaps is 1. FIG. 9F shows an example of an intermediate image obtained when the marker overlapping unit 304 converts the marker image of FIG. 9B on the basis of a marker control signal from the marker brightness setting unit 303 like FIG. 9C. In FIG. 9F, the brightness (offset amount) of the marker becomes higher (larger) than that of the case of FIG. 9C in which the number of overlaps is 1 according to the setting of the marker brightness setting unit 303 (a marker control command from the PC 102).

FIG. 9G shows an example of a marker overlapped image obtained when the marker overlapping unit 304 synthesizes the target image of FIG. 9A with the intermediate image of FIG. 9C like FIG. 9D.

FIG. 9H shows a state in which the target image of FIG. 9A that is the projection image of the projector 101 is overlapped with the marker overlapped image f FIG. 9G that is the projection image of the projector 100. In FIG. 9H, a brightness difference 901h is a brightness difference ΔC between the marker and its periphery. Brightness 902h is brightness C on the periphery of the marker and the sum of the brightness (brightness of FIG. 9G) of the projection image of the projector 100 and the brightness (brightness of FIG. 9A) of the projection image of the projector 101. In FIG. 9H, the brightness difference (offset amount) ΔC is made larger than that of the case in which the number of overlaps is 1, whereby the contrast between the marker and its periphery gets closer to the desired contrast of FIG. 9D compared with the case of FIG. 9E. As a result, it is possible to make the marker easily detectable while making the same hardly visually recognizable even in the case in which the projection image of the projector 100 and the projection image of the projector 101 are overlapped with each other (in the case in which the number of overlaps is 2).

Similarly, the brightness difference ΔC is made larger in a case in which the number of overlaps is 3 than in a case in which the number of overlaps is 2, and the brightness difference ΔC is made larger in a case in which the number of overlaps is 4 than in a case in which the number of overlaps is 3. That is, the larger the number of overlaps, the larger the brightness difference (offset amount) ΔC is made. Thus, it is possible to make the marker easily detectable while making the same hardly visually recognizable regardless of the number of projection images overlapped with each other on a projection surface. Note that the offset amount ΔC may be increased on a step by step basis with an increase in the number of overlaps at a stage at which the number of overlaps is smaller than the number of possible overlaps.

Note that when overlapped projection as shown in FIG. 1 is performed, a plurality of projectors having equivalent light-emitting characteristics are often used in general. That is, when a plurality of projectors perform projection on the basis of the same image data, projection images (the brightness and the colors of the projection images) are often equivalent to each other between the plurality of projectors. In this case, the CPU 501 of the PC 102 preferably determines an offset amount VL in proportion to the number L of overlaps as shown in the following formula 2 and sets the same in the projector 100. Thus, it is possible to more accurately (more reliably) make a marker easily detectable while making the same hardly visually recognizable. Note that in formula 2, “V” represents an offset amount in a case in which the number of overlaps is 1.

VL=L×V (Formula 2)

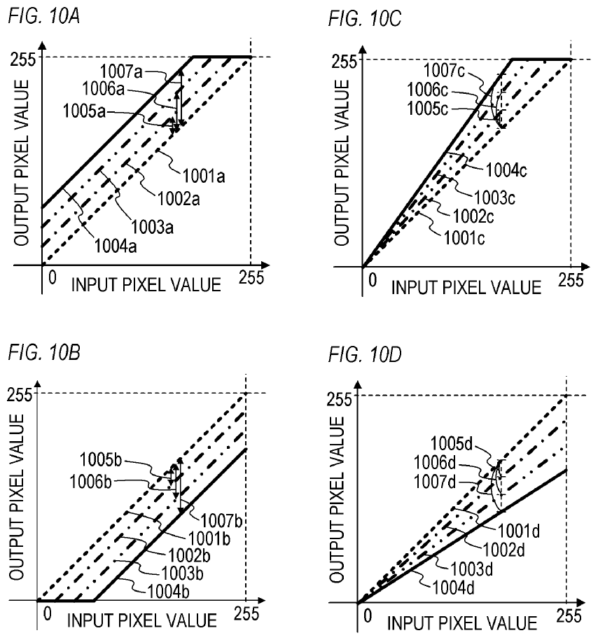

An example of the corresponding relationship between a change in the pixel value (the gradation value or the brightness value) of a target image when a marker is drawn and the number of overlaps will be described with reference to FIGS. 10A and 10B. The horizontal axis of FIGS. 10A and 10B shows the pixel value of a target image before a marker is drawn (the pixel value of a portion at which the marker is drawn), specifically, the input pixel value of the image input unit 206 or the marker overlapping unit 304. The vertical axis of FIGS. 10A and 10B shows the pixel value of the target image with which the marker has been synthesized (the pixel value of the marker in a marker overlapped image), specifically, the output pixel value of the marker overlapping unit 304.

FIG. 10A shows an example of a case in which the marker overlapping unit 304 offsets the pixel value of the target image in a positive direction to draw the marker. A dashed line 1001a shows the corresponding relationship between the input pixel value and the output pixel value in a case in which the marker is not drawn. A chain line 1002a shows the corresponding relationship in a case in which the number of overlaps is 1. As shown by the chain line 1002a, the output pixel value shown by the dashed line 1001a is offset in the positive direction by an offset amount 1005a to draw the marker in a case in which the number of overlaps is 1. A two-dot chain line 1003a shows the corresponding relationship in a case in which the number of overlaps is 2. As shown by the two-dot chain line 1003a, the output pixel value shown by the dashed line 1001a is offset in the positive direction by an offset amount 1006a that is double the offset amount 1005a to draw the marker in a case in which the number of overlaps is 2. A solid line 1004a shows the corresponding relationship in a case in which the number of overlaps is 3. As shown by the solid line 1004a, the output pixel value shown by the dashed line 1001a is offset in the positive direction by an offset amount 1007a that is triple the offset amount 1005a to draw the marker in a case in which the number of overlaps is 3.

FIG. 10B shows an example of a case in which the marker overlapping unit 304 offsets the pixel value of the target image in a negative direction to draw the marker. A dashed line 1001b shows the corresponding relationship between the input pixel value and the output pixel value in a case in which the marker is not drawn. A chain line 1002b shows the corresponding relationship in a case in which the number of overlaps is 1. As shown by the chain line 1002b, the output pixel value shown by the dashed line 1001b is offset in the negative direction by an offset amount 1005b to draw the marker in a case in which the number of overlaps is 1. A two-dot chain line 1003b shows the corresponding relationship in a case in which the number of overlaps is 2. As shown by the two-dot chain line 1003b, the output pixel value shown by the dashed line 1001b is offset in the negative direction by an offset amount 1006b that is double the offset amount 1005b to draw the marker in a case in which the number of overlaps is 2. A solid line 1004b shows the corresponding relationship in a case in which the number of overlaps is 3. As shown by the solid line 1004b, the output pixel value shown by the dashed line 1001b is offset in the negative direction by an offset amount 1007b that is triple the offset amount 1005b to draw the marker in a case in which the number of overlaps is 3.

Note that in the examples of FIGS. 10A and 10B, each of the range of the input pixel value and the range of the output pixel value falls within 0 to 255. As for pixels of which the output pixel value falls outside 0 to 255 due to an offset, their offset amounts are limited so that the output pixel value falls within 0 to 255. In the examples of FIGS. 10A and 10B, the output pixel value of pixels of which the output pixel value is above 255 due to an offset is set at 255, and the output pixel value of pixels of which the output pixel value is below 0 due to an offset is set at 0.

As shown in FIGS. 10A and 10B, the offset amounts of the pixel values are increased as the number of overlaps is larger to draw the marker regardless of an offset direction in the first embodiment.

Operations in Case in Which Deviation of Projection Area of Projector 100 is Corrected

The operations of the PC 102, the camera 103, and the projector 100 in a case in which the deviation of a projection area of the projector 100 is corrected will be described. The following operations are performed in a state in which the projector 100 projects a marker in which its brightness has been adjusted by an adjustment operation described above, specifically, a marker overlapped image in which marker brightness has been adjusted.

Operation of PC 102

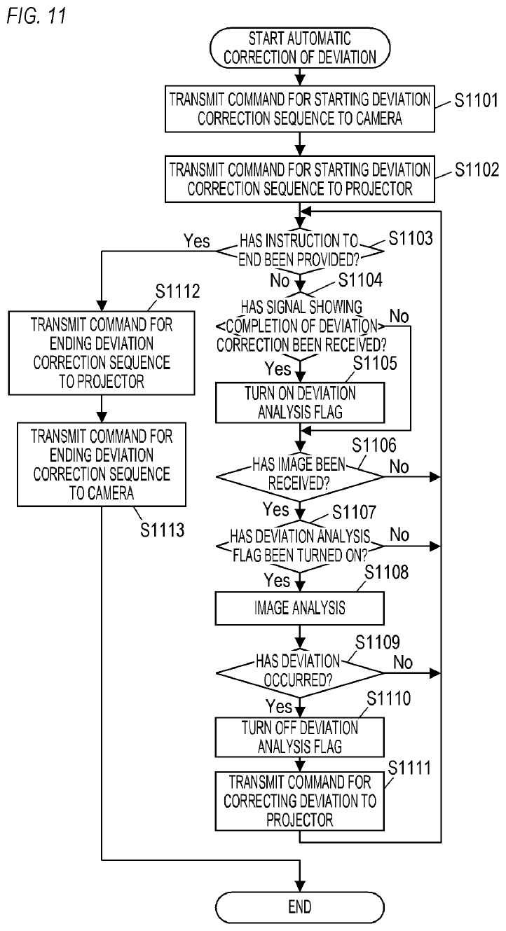

The operation of the PC 102 in a case in which the deviation of a projection area of the projector 100 is corrected will be described with reference to FIG. 11. FIG. 11 is a flowchart showing an example of the operation of the PC 102 in a case in which the deviation of a projection area of the projector 100 is corrected. The CPU 501 of the PC 102 starts the operation of FIG. 11 as a user provides an instruction to start the correction (automatic correction) of the deviation of a projection area via the operation unit 504.

In S1101, the CPU 501 transmits a command for starting a deviation correction sequence to the camera 103 via the communication unit 506. Thus, the camera 103 is allowed to start the deviation correction sequence.

In S1102, the CPU 501 transmits a command for starting a deviation correction sequence to the projector 100 via the communication unit 506. Thus, the projector 100 is allowed to start the deviation correction sequence.

In S1103, the CPU 501 determines whether an instruction to end the automatic correction of the deviation of the projection area has been provided from the user via the communication unit 506 or the operation unit 504. The processing proceeds to S1112 when it is determined that the ending instruction has been provided. Otherwise (when it is determined that the ending instruction has not been provided), the processing proceeds to S1104.

In S1112, the CPU 501 transmits a command for ending the deviation correction sequence to the projector 100 via the communication unit 506. In S1113, the CPU 501 transmits a command for ending the deviation correction sequence to the camera 103 via the communication unit 506.

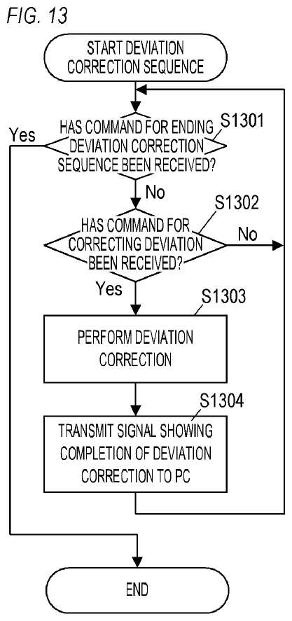

In S1104, the CPU 501 determines whether a signal showing the completion of the deviation correction has been received via the communication unit 506. The signal is transmitted from the projector 100 to the PC 102 in S1304 of FIG. 13 that will be described later. The processing proceeds to S1105 when it is determined that the signal showing the completion of the deviation correction has been received. Otherwise (when it is determined that the signal showing the completion of the deviation correction has not been received), the processing proceeds to S1106.

In S1105, the CPU 501 turns on a deviation analysis flag. Here, the deviation analysis flag is a flag used by the CPU 501 to switch between the analysis of the deviation of the projection area (the processing of S1108 that will be described later) and the transmission of a command for correcting the deviation (the processing of S1111 that will be described later) according to the processing state of the projector 100. By the processing of S1105 and other processing (the processing of S1107 and S1110 that will be described later) related to the deviation analysis flag, the CPU 501 is allowed to transmit a command for correcting the deviation to the projector 100 in a state in which the projector 100 has not completed the deviation correction. In addition, the CPU 501 is allowed to perform control so that the command for correcting the deviation is not doubly transmitted to the projector 100.

Note that the deviation analysis flag is turned on or turned off, and the state of the deviation analysis flag is retained in the RAM 502 or the HDD 503. The state (initial state) of the deviation analysis flag is turned on at a point at which the operation of FIG. 11 starts.

Note that any type of information other than the deviation analysis flag may be used so long as the information allows the discrimination of the processing state (the state of the deviation correction) of the projector 100. A flag having a polarity opposite to that of the deviation analysis flag may be, for example, used. In this case, the flowchart of FIG. 11 may be modified so that the processing is performed with the polarity opposite to that of the deviation analysis flag at the determination or the setting of the flag. Further, a variable showing the state of the projector 100 may be used instead of the flag.

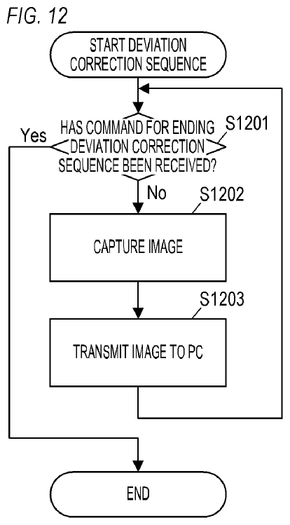

In S1106, the CPU 501 determines whether a captured image obtained by capturing a projection surface has been received from the camera 103. Note that the captured image is transmitted from the camera 103 to the PC 102 in S1203 of FIG. 12 that will be described later. The processing proceeds to S1107 when it is determined that the captured image has been received. Otherwise (when it is determined that the captured image has not been received), the processing returns to S1103.

In S1107, the CPU 501 determines whether the deviation analysis flag has been turned on. The processing proceeds to S1108 when it is determined that the deviation analysis flag has been turned on. Otherwise (when it is determined that the deviation analysis flag has not been turned on (i.e., the deviation analysis flag has been turned off)), the processing returns to S1103.

In S1108, the CPU 501 analyzes the captured image received in S1106 and detects a marker from the captured image (detector).

In S1109, the CPU 501 determines whether a deviation has occurred in the projection area on the basis of the detection result of the marker in S1108. The processing proceeds to S1110 when it is determined that the deviation has occurred in the projection area. Otherwise (when it is determined that the deviation has not occurred in the projection area), the processing proceeds to S1103. Note that the CPU 501 detects not only the presence or absence of the deviation of the projection area but also the amount of the deviation from the detected marker.

In S1110, the CPU 501 turns off the deviation analysis flag.

In S1111, the CPU 501 transmits a command for correcting the deviation of the projection area to the projector 100. Note that the command may be any type of a command so long as the command allows the correction of the deviation of the projection area. A command showing correction parameters or a command showing the amount or the direction of the deviation may be, for example, used. By the transmission of the command in S1111, the control of the projection area of the projector 100 is allowed.

Operation of Camera 103

The operation of the camera 103 in a case in which the deviation of a projection area of the projector 100 is corrected will be described with reference to FIG. 12. FIG. 12 is a flowchart showing an example of the operation of the camera 103 in a case in which the deviation of a projection area of the projector 100 is corrected. Upon receiving an instruction to start a deviation correction sequence from the PC 102 via the communication unit 607, the CPU 601 of the camera 103 starts the operation of FIG. 12.

In S1201, the CPU 601 determines whether a command for ending the deviation correction sequence has been received via the communication unit 607. The command is transmitted from the PC 102 to the camera 103 in S1113 of FIG. 11 that is described above. The CPU 601 ends the operation of FIG. 12 when it is determined that the command for ending the deviation correction sequence has been received. Otherwise (when it is determined that the command for ending the deviation correction sequence has not been received), the processing proceeds to S1202.

In S1202, the CPU 601 provides an instruction to the imaging control unit 605 so that the imaging unit 606 captures a projection surface.

In S1203, the CPU 601 transmits the image captured in S1202 to the PC 102 via the communication unit 607. Then, the processing returns to S1201. Accordingly, the camera 103 sequentially performs processing to capture the projection surface and transmit the captured image to the PC 102 until the command for ending the deviation correction sequence has been received.

Operation of Projector 100

The operation of the projector 100 in a case in which the deviation of a projection area of the projector 100 is corrected will be described with reference to FIG. 13. FIG. 13 is a flowchart showing an example of the operation of the projector 100 in a case in which the deviation of a projection area is corrected by the projector 100. Upon receiving an instruction to start a deviation correction sequence from the PC 102 via the communication unit 205, the CPU 201 of the projector 100 starts the operation of FIG. 13. Note that the flowchart of FIG. 13 is a sub-flow chart of S410 of FIG. 4.

In S1301, the CPU 201 determines whether a command for ending a deviation correction sequence has been received via the communication unit 205. The command is transmitted from the PC 102 to the projector 100 in S1112 of FIG. 11 that is described above. When it is determined that the command for ending the deviation correction sequence has been received, the CPU 201 ends the operation of FIG. 13. Otherwise (when it is determined that the command for ending the deviation correction sequence has not been received), the processing proceeds to S1302.

In S1302, the CPU 201 determines whether a command for correcting the deviation of a projection area has been received via the communication unit 205. The command is transmitted from the PC 102 to the projector 100 in S1111 of FIG. 11 that is described above. The processing proceeds to S1303 when it is determined that the command for correcting the deviation of the projection area has been received. Otherwise (when it is determined that the command for correcting the deviation of the projection area has not been received), the processing returns to S1301.

In S1303, the CPU 201 corrects (changes) the projection area (a position, a size, a shape, or the like) to reduce the deviation of the projection area of (the projector 100) itself, on the basis of the command (command for correcting the deviation of the projection area) received in S1302. Specifically, the CPU 201 sets parameters for correcting the deviation in the geometric correction unit 305. The parameters for correcting the deviation is generated by the CPU 201 on the basis of the command received in S1302. The parameters for correcting the deviation are, for example, parameters for geometric correction and used when the geometric correction unit 305 outputs an input image after converting the same by trapezoidal correction, an electronic image shift, or the like.

In S1304, the CPU 201 transmits a signal showing the completion of the deviation correction to the PC 102 via the communication unit 205. The signal showing the completion of the deviation correction is, for example, a prescribed character string or the like. Then, the processing returns to S1301.

As described above, the brightness of a marker is controlled on the basis of the number of overlaps according to the first embodiment. Thus, it is possible to make a marker easily detectable while making the same hardly visually recognizable regardless of the number of projection images overlapped with each other on a projection surface.

Note that an example in which the marker brightness of only the projector 100 is adjusted is described above. However, the adjustment of marker brightness is not limited to the example. For example, a plurality of images on which respective markers are drawn may be projected by a plurality of projectors, and the marker brightness of the plurality of projectors may be adjusted. Specifically, both the marker brightness of the projector 100 and the marker brightness of the projector 101 may be adjusted. In this case, the projector 101 includes the same configuration as that of the projector 100, and the marker brightness of the projector 101 is adjusted by the same adjustment method as that of the marker brightness of the projector 100. Thus, it is possible to make a marker easily detectable while making the same hardly visually recognizable regardless of the number of projection images overlapped with each other on a projection surface for each of a plurality of projectors. The marker brightness of the plurality of projectors may be controlled (to be the same) in a lump, or may be separately controlled.

Note that an example in which the deviation correction (the control of a projection area) of only the projector 100 is performed is described above. However, the deviation correction is not limited to the example. For example, a plurality of images on which respective markers have been drawn may be projected by a plurality of projectors, and the projection areas of the respective projectors may be separately controlled on the basis of the detection results of the markers after the detection of the markers of the respective projectors. Specifically, the deviation correction of the projector 100 and the deviation correction of the projector 101 may be separately performed. In this case, the projector 101 includes the same configuration as that of the projector 100, and the deviation correction of the projector 101 is performed like the deviation correction of the projector 100.

Note that the markers of respective projectors may be drawn in such a manner that the plurality of projectors project the plurality of markers so as to be spatially deviated from each other. In this manner, the CPU 501 of the PC 102 is allowed to easily discriminate the markers of respective projectors using spatial position information on detected markers. As a result, it is possible to improve accuracy in the deviation correction of the respective projectors. For example, a marker of the projector 100 and a marker of the projector 101 may be drawn so as not to be overlapped with each other on a projection surface. In this manner, the CPU 501 is allowed to easily distinguish the marker of the projector 100 from the marker of the projector 101 using spatial position information on the detected markers. As a result, it is possible to improve accuracy in the deviation correction of the projector 101 and accuracy in the deviation correction of the projector 100.

Further, markers of respective projectors may be drawn in such a manner that the plurality of projectors project the plurality of markers with a time lag. Specifically, only one projector may be allowed to project a marker at a certain timing, and a projector that projects a marker may be switched every time capturing by the camera 103. In this manner, the CPU 501 is allowed to easily discriminate markers of respective projectors using information on the imaging timing of captured images.

### Second Embodiment

Hereinafter, a second embodiment of the present invention will be described. Note that points (configurations, processing, or the like) different from those of the first embodiment will be described in detail and the same points as those of the first embodiment will be omitted. In the second embodiment, the entire configuration of a projector, the internal configuration of an image processing unit, and the basic operation of the projector are the same as those of the first embodiment unless otherwise specifically noted.

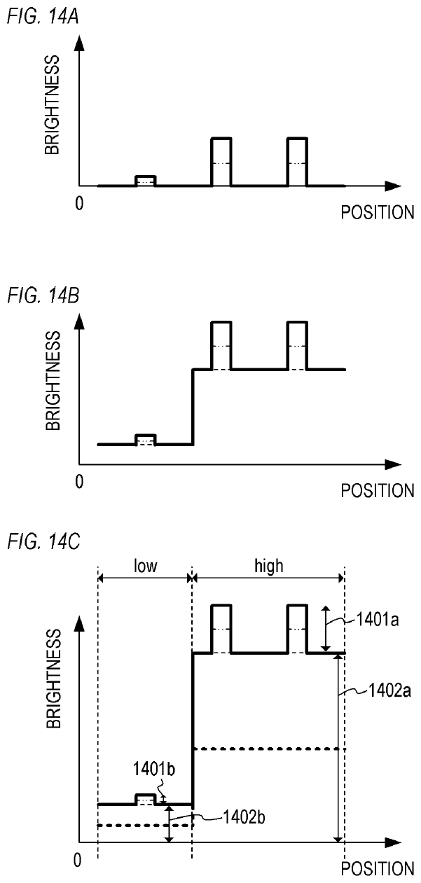

The first embodiment describes an example in which the brightness of a marker is adjusted to brightness corresponding to the number of overlaps of projection images. The second embodiment will describe an example in which the brightness of a marker is adjusted to brightness corresponding to a combination of the number of overlaps of projection images and the pixel value of a target image. By the adjustment of the brightness of a marker in consideration of the pixel value of a target image in addition to the number of overlaps of projection images, it is possible to make the marker easily detectable while making the same hardly visually recognizable regardless of the pixel value of the target image. The mechanism will be described with reference to FIGS. 14A to 14C and FIGS. 9A to 9H. FIGS. 14A to 14C schematically show the drawn state of a marker using a horizontal axis showing a pixel position and a vertical axis showing brightness.

FIG. 14A shows an example of an intermediate image generated when the marker overlapping unit 304 converts the marker image of FIG. 9B on the basis of a marker control signal (in which the pixel value of a target image has been considered) from the marker brightness setting unit 303. In the second embodiment, the target image (FIG. 9A) is input to the marker brightness setting unit 303 as shown by a dashed arrow in FIG. 3. FIG. 14A shows an example of a case in which the number of overlaps is 2. In the intermediate image of FIG. 9F based on only the number of overlaps=2, the marker brightness (offset amount) becomes constant regardless of the pixel value of the target image of FIG. 9A. On the other hand, in FIG. 14A, marker brightness (offset amount) in an area in which the pixel value of the target image of FIG. 9A is small becomes lower (smaller) than that of an area in which the pixel value of the target image is large.

FIG. 14B shows an example of a marker overlapped image obtained when the marker overlapping unit 304 synthesizes the target image 9A of the projector 100 with the intermediate image of FIG. 14A. FIG. 14C shows a state in which the target image of FIG. 9A that is the projection image of the projector 101 is overlapped with the marker overlapped image of FIG. 14B that is the projection image of the projector 100.

In an area “high” in which the pixel value of the target image of FIG. 9A is large among areas shown in FIG. 14C, a brightness difference (offset amount) ΔChigh between the marker and its periphery is a brightness difference 1401a. Brightness “Chigh” on the periphery of the marker is brightness 1402a and represents the sum of the brightness of the projection image of the projector 100 (the brightness of FIG. 14B) and the brightness of the projection image of the projector 101 (the brightness of FIG. 9A). On the other hand, in an area “low” in which the pixel value of the target image of FIG. 9A is small, a brightness difference (offset amount) ΔClow between the marker and its periphery is a brightness difference 1401b. Brightness “Clow” on the periphery of the marker is brightness 1402b and represents the sum of the brightness of the projection image of the projector 100 (the brightness of FIG. 14B) and the brightness of the projection image of the projector 101 (the brightness of FIG. 9A).

In the area “high,” the contract between the marker and its periphery is ΔChigh/Chigh. In the area “low,” the contrast between the marker and its periphery is ΔClow/Clow. Since the brightness “Clow” is smaller than the brightness “Chigh,” the contrast between the marker and its periphery of the area “low” becomes larger than that of the area “high” when the offset amount ΔClow equals to ΔChigh. In FIG. 14C, the offset amount ΔClow is set to be smaller than ΔChigh. Therefore, it is possible to keep the contrast between the marker and its periphery (substantially) constant regardless of the pixel value of the target image of FIG. 9A. Thus, it is possible to make a marker easily detectable while making the same hardly visually recognizable regardless of the pixel value of a target image.

An example of the corresponding relationship between a change in the pixel value (the gradation value or the brightness value) of a target image when a marker is drawn and the number of overlaps will be described with reference to FIGS. 10C and 10D. The horizontal axis of FIGS. 10C and 10D shows the pixel value of a target image before a marker is drawn (the pixel value of a portion at which the marker is drawn), specifically, the input pixel value of the image input unit 206 or the marker overlapping unit 304. The vertical axis of FIGS. 10C and 10D shows the pixel value of the target image with which the marker has been synthesized (the pixel value of the marker in a marker overlapped image), specifically, the output pixel value of the marker overlapping unit 304.

FIG. 10C shows an example of a case in which the marker overlapping unit 304 offsets the pixel value of the target image in a positive direction to draw the marker. A dashed line 1001c shows the corresponding relationship between the input pixel value and the output pixel value in a case in which the marker is not drawn. A chain line 1002c shows the corresponding relationship in a case in which the number of overlaps is 1. As shown by the chain line 1002c, the output pixel value shown by the dashed line 1001c is offset in the positive direction by a large offset amount 1005c as the input pixel value is larger to draw the marker in a case in which the number of overlaps is 1. A two-dot chain line 1003c shows the corresponding relationship in a case in which the number of overlaps is 2. As shown by the two-dot chain line 1003c, the output pixel value shown by the dashed line 1001c is offset in the positive direction by an offset amount 1006c as the input pixel value is larger to draw the marker in a case in which the number of overlaps is 2. As for the respective input pixel values, the offset amount 1006c is larger than the offset amount 1005c. A solid line 1004c shows the corresponding relationship in a case in which the number of overlaps is 3. As shown by the solid line 1004c, the output pixel value shown by the dashed line 1001c is offset in the positive direction by an offset amount 1007c as the input pixel value is larger to draw the marker in a case in which the number of overlaps is 3. As for the respective input pixel values, the offset amount 1007c becomes larger than the offset amount 1006c. In FIG. 10C, the offset amount 1005c is proportional to the input pixel value with a first proportional coefficient. The offset amount 1006c is proportional to the input pixel value with a second proportional coefficient that is double the first proportional coefficient. The offset amount 1007c is proportional to the input pixel value with a third proportional coefficient that is triple the first proportional coefficient. For this reason, as for the respective input pixel values, the offset amount 1006c becomes double the offset amount 1005c, and the offset amount 1007c becomes triple the offset amount 1005c.

FIG. 10D shows an example of a case in which the marker overlapping unit 304 offsets the pixel value of the target image in a negative direction to draw the marker. A dashed line 1001d shows the corresponding relationship between the input pixel value and the output pixel value in a case in which the marker is not drawn. A chain line 1002d shows the corresponding relationship in a case in which the number of overlaps is 1. As shown by the chain line 1002d, the output pixel value shown by the dashed line 1001d is offset in the negative direction by a large offset amount 1005d as the input pixel value is larger to draw the marker in a case in which the number of overlaps is 1. A two-dot chain line 1003d shows the corresponding relationship in a case in which the number of overlaps is 2. As shown by the two-dot chain line 1003d, the output pixel value shown by the dashed line 1001d is offset in the negative direction by an offset amount 1006d as the input pixel value is larger to draw the marker in a case in which the number of overlaps is 2. As for the respective input pixel values, the offset amount 1006d is larger than the offset amount 1005d. A solid line 1004d shows the corresponding relationship in a case in which the number of overlaps is 3. As shown by the solid line 1004d, the output pixel value shown by the dashed line 1001d is offset in the negative direction by an offset amount 1007d as the input pixel value is larger to draw the marker in a case in which the number of overlaps is 3. As for the respective input pixel values, the offset amount 1007d is larger than the offset amount 1006d. In FIG. 10C, the offset amount 1005d is proportional to the input pixel value with a first proportional coefficient. The offset amount 1006d is proportional to the input pixel value with a second proportional coefficient that is double the first proportional coefficient. The offset amount 1007d is proportional to the input pixel value with a third proportional coefficient that is triple the first proportional coefficient. For this reason, as for the respective input pixel values, the offset amount 1006d becomes double the offset amount 1005d, and the offset amount 1007d becomes triple the offset amount 1005d.

Note that in the example of FIGS. 10C and 10D, each of the range of the input pixel value and the range of the output pixel value falls within 0 to 255 like the example of FIGS. 10A and 10B. As for pixels of which the output pixel value falls outside 0 to 255 due to an offset, their offset amounts are limited so that the output pixel value falls within 0 to 255. For this reason, it is preferable to perform an offset in the negative direction as in FIG. 10D. According to the offset of FIG. 10D, the output pixel value does not fall outside 0 to 255. Therefore, it is possible to more reliably make a marker easily detectable (it is possible to prevent the marker from being hardly detected with the limitation of an offset amount).

As shown in FIGS. 10C and 10D, the offset amounts of the pixel values are increased as the number of overlaps is larger and the offset amounts of the pixel values are increased as the size of the input pixel value is larger to draw the marker regardless of an offset direction in the second embodiment.

Internal Configuration of Image Processing Unit 207

In the second embodiment, the configuration of the marker brightness setting unit 303 is modified as follows from the configuration of the first embodiment. As described above, a target image is input to the marker brightness setting unit 303 (as shown by the dashed arrow of FIG. 3) in the second embodiment. Further, the marker brightness setting unit 303 determines an offset amount corresponding to a combination of the number of overlaps of projection images and the pixel value of a target image, on the basis of an offset amount corresponding to a marker control command from the PC 102 (an offset amount corresponding to only the number of overlaps) and the pixel value of the target image. The offset amount is determined for each image area (pixel) in which a marker is drawn. Then, the marker brightness setting unit 303 generates and outputs a marker control signal on the basis of the determined offset amount (in which the pixel value of the target image has been considered). The marker brightness setting unit 303 determines (calculates) an offset amount VI using, for example, the following formula 3. In formula 3, “Vb” represents an offset amount corresponding to a marker control command from the PC 102 (an offset amount corresponding to only the number of overlaps), “I” represents the pixel value of a target image, and “Im” represents the maximum value of a pixel value possibly taken by the target image. Note that when an offset amount VI is determined with respect to an image area composed of a plurality of pixels, the representative value (such as the average value, the intermediate value, the mode, the maximum value, and the minimum value) of a pixel value in a target image area is only required to be used as the pixel value I.

VI=Vb×I/Im (Formula 3)

As a result of the above processing by the marker brightness setting unit 303, it is possible to make the offset amount of a marker larger as an input pixel value is larger like the corresponding relationship between the lines 1002c and 1004c shown in FIG. 10C and the corresponding relationship between the lines 1002d and 1004d shown in FIG. 10D.

Note that the maximum value Im of a pixel value possibly taken by a target image depends on the target image in some cases. For this reason, the CPU 201 may set the maximum value Im in the marker brightness setting unit 303 at a prescribed timing. The prescribed timing is, for example, the timing of the projection start processing (S401 of FIG. 4) or the timing of the input switching processing (S403).

Note that a target image may be input to the PC 102. The CPU 501 of the PC 102 may determine an offset amount corresponding to a combination of the number of overlaps of projection images and the pixel value of the target image (offset amounts of respective image areas (respective pixels)) and output a marker control command based on the offset amounts.

As described above, the brightness of a marker is controlled on the basis of the number of overlaps of projection images and the pixel value of a target image according to the second embodiment. Thus, it is possible to make a marker easily detectable while making the same hardly visually recognizable regardless of the number of overlaps of projection images and the pixel value of a target image.

### Third Embodiment

Hereinafter, a third embodiment of the present invention will be described. Note that points (configurations, processing, or the like) different from those of the first embodiment will be described in detail and the same points as those of the first embodiment will be omitted. In the third embodiment, the entire configuration of a projector, the internal configuration of an image processing unit, and the basic operation of the projector are the same as those of the first embodiment unless otherwise specifically noted.

The first embodiment describes an example in which an image having high brightness is projected onto a projection surface with a plurality of projection images overlapped with each other so that the entire area of a projection image is overlapped with the entire area of another projection image. The third embodiment will describe an example of tile projection in which an image having high resolution (a synthetic image composed of a plurality of projection images projected from a plurality of projectors) is displayed on a projection surface with a part of a projection image and a part of another projection image overlapped with each other.

Note that in the case of tile projection, the edge blend correction unit 301 adjusts the total of pixel values as a result of an overlap to be equivalent to a pixel value (a pixel value before edge blending) in projection with a single projector by performing the edge blending (dimmer processing) of an overlapped area. In this case, a reduction in contrast depending on the pixel value of a target image is not likely to occur as a reduction in the contrast of a marker due to an overlap. However, a reduction in contrast depending on the black floating of a projector occurs as a reduction in the contrast of a marker due to an overlap. For this reason, in the case of the tile projection, the brightness of a marker is desirably increased to prevent the influence of an increase in the brightness of a projection surface due to black floating.

Internal Configuration of Image Processing Unit 207

In the third embodiment, the configuration of the marker brightness setting unit 303 is modified as follows from the configuration of the first embodiment. In the third embodiment, a signal showing the image area of a target image is input to the marker brightness setting unit 303 by a synchronization signal generation unit not shown. The signal showing the image area of the target image is, for example, a vertical/horizontal synchronization signal, a signal showing the start/end position of an edge blend area (an area overlapped with another projection image), or the like. These signals are output from the synchronization signal generation unit when the CPU 201 sets a prescribed value in the synchronization signal generation unit. The prescribed value is projection resolution (resolution of a synthesized image), a value showing the width of an edge blend area, or the like.

Further, the marker brightness setting unit 303 switches a marker control signal for each image area and outputs the selected marker control signal to the marker overlapping unit 304 according to a signal from the synchronization signal generation unit. The CPU 201 sets the offset amounts of respective image areas in the marker brightness setting unit 303, and the marker brightness setting unit 303 generates and outputs the marker control signals of the respective image areas on the basis of the set offset amounts.

Operation of Adjusting Marker Brightness by PC 102

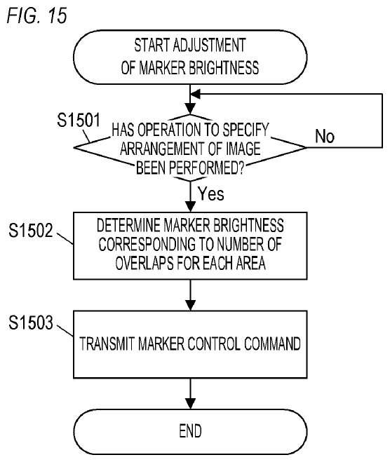

The operation of adjusting marker brightness by the PC 102 will be described with reference to FIG. 15. FIG. 15 is a flowchart showing an example of the operation of adjusting marker brightness by the PC 102 and is a modification of the flowchart of FIG. 7.

In S1501, the CPU 501 determines whether a user operation to specify the arrangement of a projection image of the projector 100 has been performed. The processing proceeds to S1502 when it is determined that the user operation to specify the arrangement of the projection image has been performed. Otherwise (when it is determined that the user operation to specify the arrangement of the projection image has not been performed), the processing of S1501 is repeatedly performed until the user operation to specify the arrangement of the projection image has been performed.

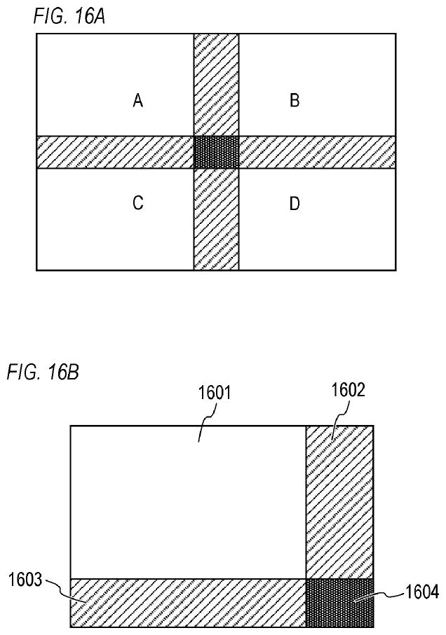

The specification of the arrangement of projection images will be described with reference to FIGS. 16A and 16B. FIG. 16A is a view showing an example of a state in which a plurality of projection images are overlapped with each other in tile projection. In the example of FIG. 16A, projection images A to D of four projectors are arranged so that two projection images are arranged side by side in a vertical direction and two projection images are arranged side by side in a horizontal direction. FIG. 16B is an enlarged view (detail view) of the projection image A shown by thick lines of FIG. 16A. An image area 1601 of FIG. 16B is an image area not overlapped with other projection images, and the image areas 1602 to 1604 are edge blend areas overlapped with other projection images.

The specification of the arrangement of projection images is the specification of the number of projection images arranged side by side in the horizontal and vertical directions, the specification of the position of a projection image of the projector 100 in a synthesized image (a plurality of projection images), the specification of the width of an edge blend area, or the like. From these information items, the CPU 501 is allowed to determine (calculate) a plurality of image areas of which the number of overlaps is different as a plurality of image areas in a target image of the projector 100. In addition, the CPU 501 is allowed to determine the numbers of overlaps of respective image areas in a target image. In the examples of FIGS. 16A and 16B, the image area 1601 is not overlapped with other projection images, the image area 1602 is overlapped with a projection image B, the image area 1603 is overlapped with a projection image C, and the image area 1604 is overlapped with projection images B, C, and D. For this reason, the number of overlaps in the image area 1601 becomes 1, the number of overlaps in the image area 1602 becomes 2, the number of overlaps in the image area 1603 becomes 2, and the number of overlaps in the image area 1604 becomes 4.

Note that a method for specifying the arrangement of a projection image is not particularly limited so long as the CPU 501 is allowed to determine the corresponding relationship between an image area and the number of overlaps in a target image of the projector 100. For example, as a plurality of image areas in a target image of the projector 100, the CPU 501 may cause a user to directly specify a plurality of areas of which the number of overlaps is different or cause the user to directly specify the numbers of overlaps of respective image areas in the target image.

In S1502, the CPU 501 determines the brightness of a marker to be drawn on a target image, specifically, an offset amount according to the number of corresponding overlaps (the number of overlaps determined in S1501) for each image area (image area determined in S1501) of the projector 100. Here, in the projection image of the projector 100, brightness based on the pixel value of the projector 100 is N (nits), and brightness based on the black floating of the projector 100 is M (nits). Further, brightness (in front of an edge blend) on a projection surface when only the projector 100 performs projection is N+M (nits). When all the projectors perform tile projection under such a condition (the condition of the projector 100), the brightness of edge blend areas becomes N+L×M (nits) according to the number L of overlaps of the edge blend area. In this case, the CPU 501 may calculate an offset amount VL using the following formula 4. In this manner, it is possible to favorably make a marker easily detectable while making the same hardly visually recognizable in respective image areas. Note that in formula 4, “V” represents an offset amount when the number of overlaps is 1.

VL=V×(N+L×M)/(N+M) (Formula 4)

In S1503, the CPU 501 transmits a marker control command for setting marker brightness (offset amount) to the projector 100 via the communication unit 506 like S703 of FIG. 7. However, the marker control command includes information showing the image area (image area determined in S1501) of the projector 100 and includes marker information on the marker brightness (offset amount) for each image area of the projector 100. Upon receiving the marker control command via the communication unit 205, the CPU 201 of the projector 100 sets the marker brightness (offset amounts) of the respective image areas of the projector 100 in the marker brightness setting unit 303 on the basis of the received marker control command. Accordingly, as a result of the transmission of the marker control command to the projector 100 by the PC 102, the brightness of a marker to be drawn is separately controlled for each of a plurality of image areas of the target image of the projector 100.

As described above, marker brightness is separately controlled for each of a plurality of image areas of a target image according to the third embodiment. Thus, in a case in which the number of overlaps is different between a plurality of image areas of a target image like the case of tile projection (multi-projection), it is possible to make a marker easily detectable while making the same hardly visually recognizable in the respective image areas.

### Fourth Embodiment

Hereinafter, a fourth embodiment of the present invention will be described. Note that points (configurations, processing, or the like) different from those of the first embodiment will be described in detail and the same points as those of the first embodiment will be omitted. In the fourth embodiment, the entire configuration of a projector, the internal configuration of an image processing unit, and the basic operation of the projector are the same as those of the first embodiment unless otherwise specifically noted.

The first embodiment describes an example in which marker brightness is increased as the number of overlaps is larger with the use of information on the number of overlaps is described. The fourth embodiment will describe an example in which higher marker brightness is determined to be set as the number of overlaps is larger according to a recursive method using an image captured by the camera 103.

Operation of Adjusting Marker Brightness by PC 102

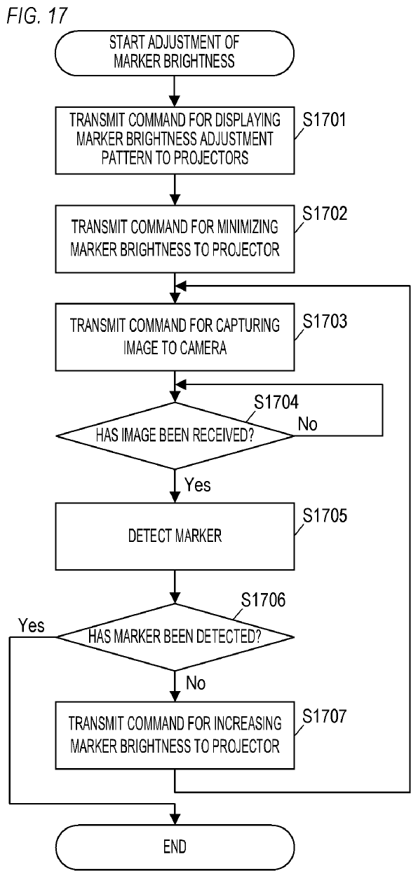

The operation of adjusting marker brightness by the PC 102 will be described with reference to FIG. 17. FIG. 17 is a flowchart showing an example of the operation of adjusting marker brightness by the PC 102. The operation of FIG. 17 is realized, for example, when the CPU 501 controls the respective blocks on the basis of a program recorded on the ROM 502. The operation of FIG. 17 starts as a user provides an instruction to start the adjustment of marker brightness using the operation unit 504. Here, the operation of FIG. 17 is performed in a state in which the projector 100 and the projector 101 perform projection as shown in FIG. 1.

In S1701, the CPU 501 transmits a command for displaying a marker brightness adjustment pattern as a target image to the projector 100 and the projector 101 via the communication unit 506. Note that the marker brightness adjustment pattern is, for example, a uniform image having a prescribed pixel value S as its pixel value. In response to the command of S1701, the CPU 201 of the projector 100 reads the marker brightness adjustment pattern stored in advance in the ROM 203. Alternatively, the CPU 201 causes the pattern generation unit not shown in FIG. 3 to generate the marker brightness adjustment pattern. The obtained pattern is input to the image processing unit 207 as a target image. Thus, the projector 100 projects the marker brightness adjustment pattern. Similarly, the projector 101 also projects the marker brightness adjustment pattern.

In S1702, the CPU 501 transmits a command for minimizing marker brightness (offset amount) to the projector 100 via the communication unit 506. In response to the command of S1702, the projector 100 draws a marker on the marker brightness adjustment pattern with the minimum brightness (offset amount) and projects the pattern on which the marker has been drawn.

In S1703, the CPU 501 transmits a command for capturing a projection surface to the camera 103 via the communication unit 506. In response to the command of S1703, the camera 103 captures the projection surface and transmits the captured image to the PC 102.

In S1704, the CPU 501 determines whether the captured image has been received from the camera 103 via the communication unit 506. The processing proceeds to S1705 when it is determined that the captured image has been received. Otherwise (when it is determined that the captured image has not been received), the processing of S1704 is repeatedly performed until the captured image has been received.

In S1705, the CPU 501 makes an attempt to detect the marker from the captured image received in S1704.

In S1706, the CPU 501 determines whether the marker has been detected by the processing of S1705. The CPU 501 ends the operation of FIG. 17 when it is determined that the marker has been detected. Otherwise (when it is determined that the marker has not been detected), the processing proceeds to S1707.

In S1707, the CPU 501 transmits a command for increasing the marker brightness of the projector 100 to the projector 100 via the communication unit 506. For example, the CPU 501 retains marker brightness (offset amount) set by a previous command in the RAM 502 in advance and transmits a command for setting marker brightness (offset amount) higher than the marker brightness retained in the RAM 502. In response to the command of S1707, the projector 100 increases the marker brightness. Then, the processing returns to S1703. Thus, the marker brightness (offset amount) is gradually increased until the marker is detected from a captured image.

As described above, marker brightness (offset amount) is gradually increased until a marker is detected from a captured image according to the fourth embodiment. Thus, marker brightness is allowed to be controlled to minimum brightness which is higher as the number of overlaps is larger and with which it possible to detect a marker from a captured image. As a result, it is possible to make a marker easily detectable while making the same hardly visually recognizable regardless of the number of projection images overlapped with each other on a projection surface.

Note that when a marker brightness adjustment pattern is a uniform image having a uniform pixel value S as its pixel value, marker brightness (offset amount) is allowed to be controlled to brightness with which the marker is suitably drawn in the area of the pixel value S by the operation of FIG. 17. An offset amount VS' corresponding to another pixel value S′ is calculatable from an offset amount VS corresponding to the pixel value S using, for example, the following formula 5. By obtaining the offset amounts of respective pixel values, similarly to the second embodiment it is possible to control marker brightness to brightness based on the number of overlaps of projection images and the pixel value of a target image.

VS′=VS×S′/S (Formula 5)

Note that in S1706, the CPU 501 may determine whether the marker has been detected for each image area of the target image. Then, in S1707, the CPU 501 may transmit the command for increasing the marker brightness for each image area and control the marker brightness for each image area. In this manner, similarly to the third embodiment it is possible to favorably control the marker brightness of respective image areas when the number of overlaps is different between the plurality of image areas of a target image like the case of tile projection (multi-projection) or the like. In this case, the target image may not be a marker brightness adjustment pattern. Like the second embodiment, it is possible to favorably control the marker brightness of the respective image areas when a pixel value is different between the plurality of image areas of the target image.

### Fifth Embodiment

Hereinafter, a fifth embodiment of the present invention will be described. Note that points (configurations, processing, or the like) different from those of the first embodiment will be described in detail and the same points as those of the first embodiment will be omitted. In the fifth embodiment, the entire configuration of a projector, the internal configuration of an image processing unit, and the basic operation of the projector are the same as those of the first embodiment unless otherwise specifically noted.

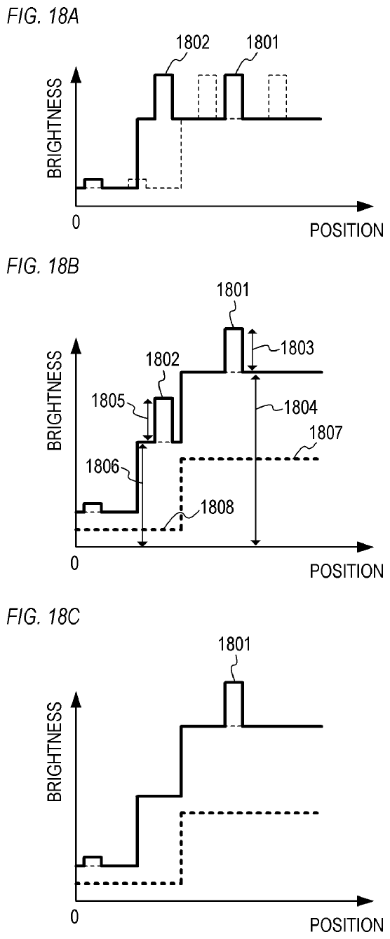

The fifth embodiment will describe the operation of making the marker brightness (offset amount) of a portion having a large brightness difference lower than the marker brightness of the other portion (a portion having a small brightness difference) on a projection surface in addition to the adjustment of marker brightness corresponding to the number of overlaps of projection images. The portion having a large brightness difference on the projection surface is, for example, the edge portion (a portion having a high spatial frequency) of a projection image (target image) of the projector 100, the end portion of a projection image (target image) of the projector 100, the end portion of an edge blend area, or the like. The edge blend area may also be regarded as the end portion of a projection image (target image) of the projector 100. By reducing the marker brightness (offset amount) of a portion having a large brightness difference, it is possible to prevent a marker from being easily visually recognized due to the deviation of a projection area. The mechanism will be described with reference to FIGS. 18A to 18C.

FIG. 18A shows a state in which the marker overlapped image of FIG. 14B is projected by the projector 100 so as to be deviated. A desired marker overlapped image without a deviation is shown by a dashed line, and an actual marker overlapped image with a deviation is shown by a solid line. A marker 1801 is a marker drawn in an area (a portion having a small brightness difference) in which the pixel value of a target image is equivalent to the pixel value of its periphery. A marker 1802 is a marker drawn in an area (a portion having a large brightness difference) in which the pixel value of the target image is not equivalent to the pixel value of its periphery.

FIG. 18B shows a state in which the target image of FIG. 14A is projected by the projector 101 so as not to be deviated with respect to the state of FIG. 18A. (The brightness of) the projection image of the projector 101 is shown by a dashed line. The sum of the brightness of the projection image of the projector 100 and the brightness of the projection image of the projector 101 is shown by a solid line.

At this time, even if the projection image of the projector 100 is deviated, the marker 1801 drawn at the portion having a small brightness difference easily overlapped with an image area having brightness equivalent to brightness 1807 of the projector 101. For this reason, the contrast between the marker 1801 and its periphery is easily maintained even if the projection image of the projector 100 is deviated. In FIG. 18B, a brightness difference (offset amount) ΔC between the marker 1801 and its periphery is a brightness difference 1803. Further, brightness C on the periphery of the marker 1801 is brightness 1804 that is the sum of the brightness (brightness of FIG. 18A) of the projection image of the projector 100 and the brightness 1807 of the projection image of the projector 101. At this time, the contrast (the brightness difference 1803/the brightness 1804) between the marker 1801 and its periphery is equivalent to that of FIG. 14C. As described above, the contrast between the marker 1801 and its periphery (a state in which the marker 1801 is hardly visually recognized) is easily maintained even if the projection image of the projector 100 is deviated.

On the other hand, the marker 1802 drawn at the portion having a large brightness difference is easily overlapped with the image area of brightness 1808 lower than the brightness 1807 of the projector 101 when the projection image of the projector 100 is deviated. For this reason, there is a likelihood that the contrast between the marker 1802 and its periphery becomes too high when the projection image of the projector 100 is deviated. In FIG. 18B, a brightness difference (offset amount) ΔC between the marker 1802 and its periphery is a brightness difference 1805. Further, brightness C on the periphery of the marker 1802 is brightness 1806 (<brightness 1804) that is the sum of the brightness (brightness of FIG. 18A) of the projection image of the projector 100 and the brightness 1808 of the projection image of the projector 101. At this time, the contrast (the brightness difference 1805/the brightness difference 1806) between the marker 1802 and its periphery becomes higher than that of FIG. 14C, and the marker 1802 is easily visually recognized.

FIG. 18C shows a state in which the brightness (offset amount) of the marker 1802 of the portion having a large brightness difference is reduced (a state in which the marker 1802 is deleted) with respect to the state of FIG. 18B. By reducing the offset amount ΔC of the marker 1802, the contrast between the marker 1802 and its periphery is reduced. As a result, it is possible to prevent the marker 1802 from being easily visually recognized.

Note that by leaving the marker brightness (offset amount) of a portion having a small brightness difference intact, it is possible to maintain a state in which a marker is easily detected and prevent accuracy in detecting the deviation of a projection image from being reduced.

Note that when the number of overlaps is 1, it is not necessary to reduce the marker brightness of a portion having a large brightness difference. For this reason, processing to reduce the marker brightness of a portion having a large brightness difference may not be performed when the number of overlaps is 1 but may be performed when the number of overlaps is at least 2. In this manner, it is possible to further prevent accuracy in detecting the deviation of a projection image from being reduced when the number of overlaps is 1 and prevent a marker at a portion having a large brightness difference from being easily visually recognized when the number of overlaps is at least 2.

Internal Configuration of Image Processing Unit 207

In the fifth embodiment, the configuration of the marker brightness setting unit 303 is modified as follows from the configuration of the first embodiment. In the fifth embodiment, a target image is input to the marker brightness setting unit 303 (as shown by the dashed arrow of FIG. 3) like the second embodiment. Further, the marker brightness setting unit 303 includes a line buffer and is allowed to temporarily retain a target image.

The marker brightness setting unit 303 applies high-pass processing to a target image to detect an edge from the target image. When the edge is detected, the marker brightness setting unit 303 sets the offset amount of a marker at 0 for an image area within a prescribed distance α from the edge. Thus, the marker is prevented from being drawn at the edge portion of the target image.

Further, the marker brightness setting unit 303 sets the offset amount of a marker at 0 for an image area within a prescribed distance β from the end of a target image (the ends of the displayable ranges of the light modulation panels 209R, 209G, and 209B). Thus, the marker is prevented from being drawn at the end portion of the target image.

Further, the marker brightness setting unit 303 sets the offset amount of a marker at 0 for an image area within a prescribed distance γ from the end of an edge blend area. Thus, the marker is prevented from being drawn at the end portion of the edge blend area.

Note that the distances α, β, and γ are values set as a rule of thumb on the basis of, for example, a deviation amount possibly taken by a projection image and include 3 px, 5 px, or the like.

Note that a target image may be input to the PC 102, and the CPU 501 of the PC 102 may determine the offset amounts of respective image areas (respective pixels) so as not to draw a marker at a portion having a large brightness difference on a projection surface and output a marker control command based on the offset amounts.

As described above, a marker is not drawn at a portion having a large brightness difference on a projection surface according to the fifth embodiment. Thus, the marker is prevented from being easily visually recognized due to the deviation of a projection area. Note that the marker brightness (offset amount) of a portion having a large brightness difference is only required to be made lower than the marker brightness of the other portion (a portion having a small brightness difference) on the projection surface, and the marker may be drawn at the portion having the large brightness difference.

Note that the respective constituting elements of the first to fifth embodiments (including modified examples) may or may not be separate hardware. The functions of at least two blocks may be realized by common hardware. Each of a plurality of functions of a block may be realized by separate hardware. At least two functions of a block may be realized by common hardware. Further, the respective blocks may or may not be realized by hardware. For example, the apparatus may have a processor and a memory in which a control program is stored. Then, the function of at least a partial block of the apparatus may be realized when the processor reads the control program from the memory and performs the same.

Note that the first to fifth embodiments (including modified examples) are given only as an example, and configurations obtained by appropriately modifying or changing the configurations of the first to fifth embodiments within the spirit of the present invention are also included in the present invention. Configurations obtained by appropriately combining the configurations of the first to fifth embodiments together are also included in the present invention.

For example, the drawing (synthesizing) of a marker on a target image and geometric correction on a marker overlapped image may be performed by the PC 102. The projector 100 may have the function (such as the function of detecting a marker from a captured image and the function of determining an offset amount corresponding to the number of overlaps) of the PC 102.

The image processing unit 207 of the projector 100 may include a gradation conversion unit that performs gradation conversion such as gamma correction, color conversion, and HDR/SDR conversion at the previous stage of the marker overlapping unit 304. If the gradation conversion is performed before the drawing of a marker, the marker is hardly detected or easily visually recognized as the pixel value of the marker changes. With the provision of the gradation conversion unit at the previous stage of the marker overlapping unit 304, it is possible to prevent the pixel value of the marker from being changed due to the gradation conversion. Note that any processing to change a pixel value is preferably performed before the drawing of a marker for the same reason.

Further, the dot pattern described in U.S. Pat. No. 7,907,795 is shown as an example of a marker, but the present invention is applicable to any marker. The marker may be, for example, a pattern according to a gray code method, a lattice-shaped pattern, a watermark, or the like.

Further, an example in which the deviation of a projection area is corrected by the image processing of the geometric correction unit 305 is described above, but a method for correcting the deviation of the projection area is not particularly limited so long as the deviation of the projection area is correctable. The deviation of the projection area may be corrected by, for example, optically shifting or zooming a projection image with the projection optical system 214.

Further, an example in which the brightness of a target image is changed to draw a marker is described above, but a method for drawing the marker is not limited to this. The marker may be drawn by, for example, changing the hue of the target image. Further, an example in which a change amount from the brightness of a target image to the brightness of a marker is used as an offset amount is described above, but the offset amount is not limited to this. A change amount from the hue of the target image to the hue of the marker may be, for example, used as an offset amount.

Further, the image parameters (at least one of the brightness and the hue) of a marker may be arbitrarily set by a user. Thus, the brightness or the hue of the marker may be set at a desired value by the user. For example, after the setting of the brightness of the marker by the method described in the first to fifth embodiments, the user may arbitrarily set the brightness of the marker. Thus, after the automatic setting of marker brightness based on a projection system, the user is allowed to make fine adjustments to the marker brightness.

Note that in the method of the first to third examples and the fifth embodiment, it is possible to more easily determine marker brightness (in a short period of time) and adjust the marker brightness without using a camera compared with the method of the fourth embodiment. Further, in the method of the fourth embodiment, the influence of external light as well as the number of overlaps of projection images or the pixel value of a target image on the contrast of a marker is easily reduced. For this reason, the user may select any of the method of the first to third embodiments and the fifth embodiment and the method of the fourth embodiment to adjust marker brightness. Thus, the user is allowed to select the method of the first to third embodiments and the fifth embodiment when he/she wants to easily adjust marker brightness (in a short period of time). Further, the user is allowed to select the method of the fourth embodiment when he/she wants to determine more favorable marker brightness while reducing the influence of external light.

According to the present disclosure, it is possible to make a marker easily detectable while making the same hardly visually recognizable regardless of the number of projection images overlapped with each other on a projection surface.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-159697, filed on Sep. 2, 2019, which is hereby incorporated by reference herein in its entirety.

What is claimed is:

1. An image processing apparatus for drawing a marker on an image to generate a conversion image, the imaging processing apparatus comprising at least one memory and at least one processor which function as:
a generation unit configured to convert at least one of brightness and a hue of the image at a position, at which the marker is drawn, to generate the conversion image; and
an output unit configured to output the conversion image to a projection module which projects a projection image based on the conversion image, onto a projection surface, wherein
the generation unit generates the conversion image so that a difference between at least one of the brightness and the hue of the image at the position at which the marker is drawn and at least one of brightness and a hue of the conversion image at the position at which the marker is drawn becomes larger in a case where another image projected by another projection apparatus overlaps the projection image projected onto the projection surface by the projection module than in a case where another image does not overlap the projection image on the projection surface.

2. The image processing apparatus according to claim 1, wherein
the at least one memory and at least one processor which further function as a setting unit configured to set whether another image projected by another projection apparatus overlaps the projection image projected onto the projection surface by the projection module, and
the generation unit generates the conversion image so that the difference becomes larger in a case where the setting unit sets that another image overlaps the projection image on the projection surface than in a case where the setting unit sets that another image does not overlap the projection image on the projection surface.

3. The image processing apparatus according to claim 1, wherein
the generation unit generates the conversion image so that the difference in a case where a number of other images that are projected by other projection apparatuses and overlap the projection image on the projection surface is a second number, which is larger than a first number, becomes larger than the difference in a case where the number is the first number.

4. The image processing apparatus according to claim 1, wherein
the generation unit generates the conversion image so that the difference is proportional to a number of images that are projected by other projection apparatuses and overlap the projection image on the projection surface.

5. The image processing apparatus according to claim 3, wherein
the at least one memory and at least one processor which further function as a reception unit configured to receive a user operation of specifying the number of other images that are projected by other projection apparatuses and overlap the projection image on the projection surface.

6. The image processing apparatus according to claim 1, wherein
the generation unit generates the conversion image so that the difference at at least one of an end portion and an edge portion of the image becomes smaller than the difference at a portion that is neither the end portion nor the edge portion of the image.

7. The image processing apparatus according to claim 1, wherein
the generation unit generates the conversion image so that the difference gradually increases until the marker is detected by a detector configured to detect the marker from a captured image obtained by capturing an area of the projection surface including the projection image.

8. The image processing apparatus according to claim 1, wherein
at least one memory and at least one processor which further function as an area control unit configured to control a shape of an area, in which the projection module projects the projection image, on a basis of a position of the marker detected from a captured image obtained by capturing an area of the projection surface including the projection image.

9. The image processing apparatus according to claim 1, wherein
the generation unit draws a plurality of markers on the image to generate the conversion image.

10. An image processing method for drawing a marker on an image to generate a conversion image, the imaging processing method comprising:
a generation step of converting at least one of brightness and a hue of the image at a position, at which the marker is drawn, to generate the conversion image; and
an output step of outputting the conversion image to a projection module which projects a projection image based on the conversion image, onto a projection surface, wherein
in the generation step, the conversion image is generated so that a difference between at least one of the brightness and the hue of the image at the position at which the marker is drawn and at least one of brightness and a hue of the conversion image at the position at which the marker is drawn becomes larger in a case where another image projected by another projection apparatus overlaps the projection image projected onto the projection surface by the projection module than in a case where another image does not overlap the projection image on the projection surface.

11. The image processing method according to claim 10, further comprising
a setting step of setting whether another image projected by another projection apparatus overlaps the projection image projected onto the projection surface by the projection module, wherein
in the generation step, the conversion image is generated so that the difference becomes larger in a case where in the setting step, it is set that another image overlaps the projection image on the projection surface than in a case where in the setting step, it is set that another image does not overlap the projection image on the projection surface.

12. The image processing method according to claim 10, wherein
in the generation step, the conversion image is generated so that the difference in a case where a number of other images that are projected by other projection apparatuses and overlap the projection image on the projection surface is a second number, which is larger than a first number, becomes larger than the difference in a case where the number is the first number.

13. The image processing method according to claim 10, wherein
in the generation step, the conversion image is generated so that the difference is proportional to a number of images that are projected by other projection apparatuses and overlap the projection image on the projection surface.

14. The image processing method according to claim 12, further comprising
a reception step of receiving a user operation of specifying the number of other images that are projected by other projection apparatuses and overlap the projection image on the projection surface.

15. The image processing method according to claim 10, wherein
in the generation step, the conversion image is generated so that the difference at at least one of an end portion and an edge portion of the image becomes smaller than the difference at a portion that is neither the end portion nor the edge portion of the image.

16. The image processing method according to claim 10, wherein
in the generation step, the conversion image is generated so that the difference gradually increases until the marker is detected by a detector configured to detect the marker from a captured image obtained by capturing an area of the projection surface including the projection image.

17. The image processing method according to claim 10, further comprising
an area control step of controlling a shape of an area, in which the projection module projects the projection image, on a basis of a position of the marker detected from a captured image obtained by capturing an area of the projection surface including the projection image.

18. The image processing method according to claim 10, wherein
in the generation step, a plurality of markers are drawn on the image to generate the conversion image.

19. A non-transitory computer readable medium that stores a program, wherein the program causes a computer to execute an image processing method for drawing a marker on an image to generate a conversion image, the imaging processing method comprising:
a generation step of converting at least one of brightness and a hue of the image at a position, at which the marker is drawn, to generate the conversion image; and
an output step of outputting the conversion image to a projection module which projects a projection image based on the conversion image, onto a projection surface, wherein
in the generation step, the conversion image is generated so that a difference between at least one of the brightness and the hue of the image at the position at which the marker is drawn and at least one of brightness and a hue of the conversion image at the position at which the marker is drawn becomes larger in a case where another image projected by another projection apparatus overlaps the projection image projected onto the projection surface by the projection module than in a case where another image does not overlap the projection image on the projection surface.
